(19) United States
(12) Patent Application Publication
(10) Pub. No.: US 2026/0201850 A1
(43) Pub. Date: Jul. 16, 2026

(54) GAS TURBINE ENGINE WITH THIRD STREAM

(71) Applicant: General Electric Company, Cincinnati, OH (US)

(72) Inventors: Brandon W. Miller, Evendale, OH (US); Randy M. Vondrell, Evendale, OH (US); David M. Ostdiek, Evendale, OH (US); Craig W. Higgins, Evendale, OH (US); Alexander Simpson, Evendale, OH (US)

(73) Assignee: General Electric Company, Cincinnati, OH (US)

(21) Appl. No.: 19/039,639

(22) Filed: Jan. 28, 2025

Related U.S. Application Data
(63) Continuation-in-part of application No. 18/888,873, filed on Sep. 18, 2024, now Pat. No. 12,410,763.
Application No. 18/888,873 is a continuation-in-part of application No. 18/675,270, filed on May 28, 2024, now Pat. No. 12,523,188.
Application No. 18/675,270 is a continuation of application No. 17/879,384, filed on Aug. 2, 2022, now Pat. No. 12,031,504.

(51) Int. Cl. F02K 3/065; F02C 3/06

(52) U.S. Cl. CPC F02K 3/065; F02C 3/06

(57) ABSTRACT

A gas turbine engine includes a turbomachine defining an engine inlet to an inlet duct, a fan duct inlet to a fan duct, and a core inlet to a core duct; a variable pitch primary fan driven by the turbomachine; a secondary fan located downstream of the primary fan within the inlet duct; and a fluid transfer system for supplying fluid to the primary fan. The gas turbine engine defines a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct.

### CROSS-REFERENCE TO RELATED APPLICATIONS

This application is a continuation-in-part application of U.S. application Ser. No. 18/888,873, filed Sep. 18, 2024, which is a continuation-in-part of U.S. application Ser. No. 18/675,270, filed May 28, 2024, which is a continuation application of U.S. application Ser. No. 17/879,384, filed Aug. 2, 2022, now U.S. Pat. No. 12,031,504, each of which is incorporated by reference herein in their entireties.

### FIELD

The present disclosure relates to gas turbine engines for aircraft.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel an aircraft in flight. The turbomachine is mechanically coupled to the fan for driving the fan during operation.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a three stream engine in accordance with an exemplary embodiment of the present disclosure.

FIG. 2 is a close-up, schematic view of the exemplary three stream engine of FIG. 1.

FIG. 3 is a close-up view of an area surrounding a leading edge of a core cowl of the exemplary three stream engine of FIG. 2.

FIGS. 4A through 4H are tables depicting numerical values showing the relationships between various parameters in accordance with various example embodiments of the present disclosure.

FIGS. 5A through 5D are graphs depicting a range of thrust to power airflow ratios and core bypass ratios in accordance with various example embodiments of the present disclosure.

FIG. 6 is a schematic view of a geared, ducted, turbofan engine in accordance with an exemplary aspect of the present disclosure.

FIG. 7 is a schematic view of a geared, ducted, turbofan engine in accordance with another exemplary aspect of the present disclosure.

FIG. 8 is a schematic view of an unducted gas turbine engine in accordance with another exemplary aspect of the present disclosure.

FIG. 9 is a schematic view of an unducted gas turbine engine in accordance with yet another exemplary aspect of the present disclosure.

FIG. 10 is a schematic view of an unducted gas turbine engine in accordance with still another exemplary aspect of the present disclosure.

FIG. 11 is a side view of a portion of a fluid transfer system, in accordance with an exemplary aspect of the present disclosure, that is configured to transfer a flow of fluid from a stationary member to an adjacent rotatable member.

FIG. 12 is a side view partially cutaway of a stationary transfer sleeve member of the transfer sleeve device of FIG. 11.

FIG. 13 is a perspective view of the stationary transfer sleeve member of the transfer sleeve device of FIG. 11.

FIG. 14 is a side view of a fluid transfer system in accordance with an exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The term “exemplary” means “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

The terms “optional” and “optionally” refer to features or events that may or may be present or may or may not occur. Descriptions of optional features and events include instances where the feature is present and event occurs and instances where the feature is absent and the event does not occur.

As used herein, the terms “first,” “second,” and “third” may be used interchangeably to distinguish one component from another and are not intended to signify a location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

The phrases “from X to Y” and “between X and Y” each refers to a range of values inclusive of the endpoints (i.e., refers to a range of values that includes both X and Y).

The term “third stream” refers to a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments, an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

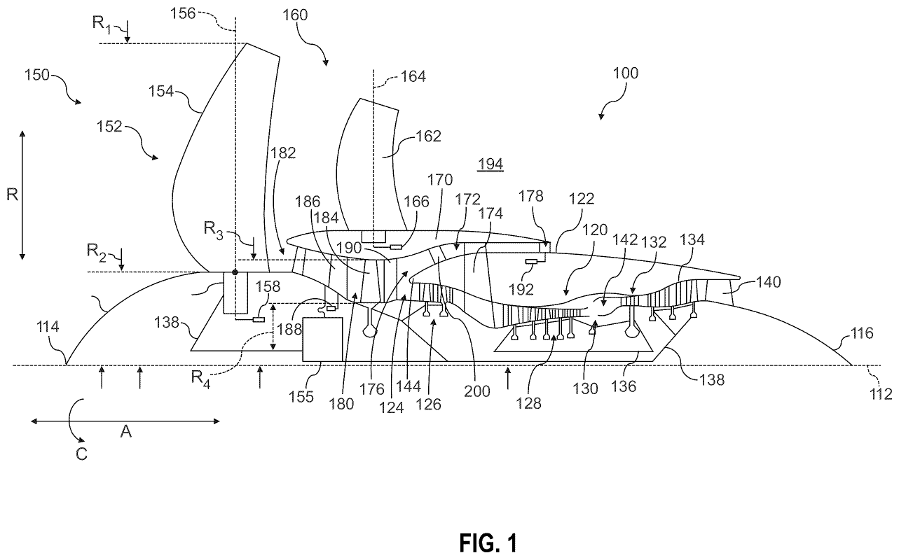

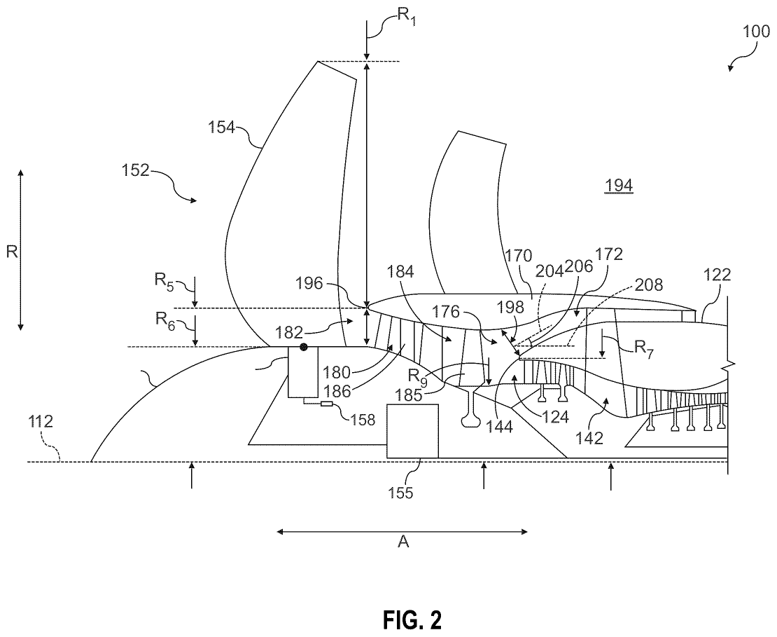

The term “bypass passage” refers generally to a passage with an airflow from a fan of the gas turbine engine that flows over an upstream-most inlet to a turbomachine of the gas turbine engine. In a ducted gas turbine engine, the bypass passage is the passage defined between an outer nacelle (surrounding the fan of the gas turbine engine) and one or more cowls inward of the outer nacelle (e.g., a fan cowl, a core cowl or both if both are present; see, e.g., FIGS. 7 through 9). In an unducted gas turbine engine, the bypass passage refers to an open sided passage (i.e., not explicitly defined by structure such as an outer nacelle) where airflow from the fan passes over an upstream-most inlet to the turbomachine (e.g., inlet 182 to inlet duct 180 in FIGS. 1 and 2), defined at least in part by a primary fan outer fan area, which refers to an area defined by an annulus representing a portion of the fan located outward of an inlet splitter at the upstream-most inlet to the turbomachine (e.g., inlet splitter 196 of the fan cowl 170 in the embodiment of FIGS. 1 and 2). An airflow through the bypass passage of a ducted or an unducted engine refers to all of the airflow from the fan that is not provided through the upstream-most inlet to the turbomachine.

The term “disk loading” refers to an average pressure change across a plurality of rotor blades of a rotor assembly, such as the average pressure change across a plurality of fan blades of a fan.

The term “rated speed” refers to an operating condition of an engine whereby the engine is operating in the maximum, full load operating condition that is rated by the manufacturer. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

Generally, an aeronautical gas turbine engine includes a fan to provide a desired amount of thrust without overloading the fan blades (i.e., without increasing a disk loading of the fan blades of the fan beyond a certain threshold), and therefore to maintain a desired overall propulsive efficiency for the gas turbine engine. Conventional gas turbine engine design practice has been to provide an outer nacelle surrounding the fan to provide relatively efficient thrust for the gas turbine engine. Such a configuration, sometimes referred to as a ducted gas turbine engine configuration, may generally limit a permissible size of the fan (i.e., a diameter of the fan). The inventors of the present disclosure have found that gas turbine engine design is now driving the diameter of the fan higher to provide as much thrust for the gas turbine engine as possible from the fan to improve an overall propulsive efficiency of the gas turbine engine.

However, simply increasing the fan diameter can result in several drawbacks. For example, by increasing the fan diameter, an installation of the gas turbine engine becomes more difficult. In addition, if an outer nacelle is maintained, the outer nacelle may become weight prohibitive with some larger diameter fans. Further, as the need for gas turbine engines to provide more thrust continues, the thermal demands on the gas turbine engines correspondingly increases.

The propulsive efficiency of the gas turbine engine can be additionally or alternatively increased by implementing the gas turbine engine's primary fan a variable pitch fan (VPF). Generally, a VPF includes a disk, fan blades extending radially outwardly from the disk, and a hydraulic pitch change mechanism (PCM) coupled to the fan blades. One or more of the fan blades of the variable pitch fan can rotate about a pitch axis to optimize airflow across the fan blades during various flight phases (e.g., takeoff, stable flight), leading to increased propulsive efficiency during the various flight phases.

However, hydraulic PCMs (and thus VPFs) require a steady supply of hydraulic fluid to operate. Conventional mechanisms (e.g., rotatable duplex bearings) for supplying hydraulic fluid to PCMs can undesirably increase the weight, size, cost, and/or complexity of the gas turbine engine.

The inventors of the present disclosure found that for a three stream gas turbine engine having a variable pitch primary fan and a ducted secondary fan, an overall propulsive efficiency of the gas turbine engine that results from providing a high diameter fan may be maintained at a high level, while reducing the size of the variable pitch primary fan. Such a configuration may maintain a desired overall propulsive efficiency for the gas turbine engine, or unexpectedly may in fact increase the overall propulsive efficiency of the gas turbine engine.

The inventors proceeded in the manner of designing a gas turbine engine with given primary fan characteristics, secondary fan characteristics, and turbomachine characteristics; checking the propulsive efficiency of the designed gas turbine engine; redesigning the gas turbine engine with varying primary fan, secondary fan, and turbomachine characteristics; rechecking the propulsive efficiency of the redesigned gas turbine engine; etc. During the course of studying and evaluating various primary fan characteristics, secondary fan characteristics, and turbomachine characteristics considered feasible for best satisfying mission requirements, the inventors discovered that certain relationships exist between a ratio of an airflow through the bypass passage and the third stream to an airflow through a core duct (referred to hereinbelow as a thrust to power airflow ratio), as well as between a ratio of an airflow through the third steam to the airflow through the core duct (referred to hereinbelow as a core bypass ratio). In particular, the inventors of the present disclosure have found that these ratios can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

The inventors of the present disclosure further found that a fluid supply conduit and a transfer sleeve device can be added to the above-disclosed three stream gas turbine engine with desirable thrust to power airflow and core bypass ratios to supply hydraulic fluid to the gas turbine engine's variable pitch primary fan. The transfer sleeve device includes a stationary transfer sleeve member and a rotatable transfer sleeve member. The transfer sleeve device is configured to receive hydraulic fluid from the fluid supply conduit and transfer the fluid across a gap between the stationary sleeve member and the rotatable transfer sleeve member to supply hydraulic fluid to the PCM of the variable pitch primary fan. Transfer sleeve devices can be lighter weight, less costly, and less complex than conventional fluid supply mechanisms (e.g., duplex bearings), and also facilitate the packaging of the pitch change mechanism in the gas turbine engine. Thus, the transfer sleeve devices can offer an improved solution for lubricating the variable pitch primary fan.

Thus, a three stream gas turbine engine including the combination of a thrust to power airflow ratio in a particular desirable range, a core bypass ratio within a particular desirable range, a variable pitch primary fan, a fluid conduit, and a transfer sleeve device can exhibit significantly improved performance (e.g., improved propulsive efficiency) over a conventional gas turbine engine.

Referring now to FIG. 1, a schematic cross-sectional view of a gas turbine engine 100 is provided according to an example embodiment of the present disclosure. Particularly, FIG. 1 provides a gas turbine engine having a rotor assembly with a single stage of unducted rotor blades. In such a manner, the rotor assembly may be referred to herein as an “unducted fan,” or the entire engine 100 may be referred to as an “unducted gas turbine engine.” In addition, the engine 100 of FIG. 1 includes a third stream extending from the compressor section to a rotor assembly flowpath over the turbomachine, as will be explained in more detail below.

For reference, the engine 100 defines an axial direction A, a radial direction R, and a circumferential direction C. Moreover, the engine 100 defines an axial centerline or longitudinal axis 112 that extends along the axial direction A. In general, the axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends between a forward end 114 and an aft end 116, e.g., along the axial direction A.

The engine 100 includes a turbomachine 120 and a rotor assembly, also referred to a fan section 150, positioned upstream thereof. Generally, the turbomachine 120 includes, in serial flow order, a compressor section, a combustion section, a turbine section, and an exhaust section. Particularly, as shown in FIG. 1, the turbomachine 120 includes a core cowl 122 that defines an annular core inlet 124. The core cowl 122 further encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air stream flows downstream to a combustor 130 of the combustion section where fuel is injected into the pressurized air stream and ignited to raise the temperature and energy level of the pressurized air.

It will be appreciated that as used herein, the terms “high/low speed” and “high/low pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The high energy combustion products flow from the combustor 130 downstream to a high pressure turbine 132. The high pressure turbine 132 drives the high pressure compressor 128 through a high pressure shaft 136. In this regard, the high pressure turbine 132 is drivingly coupled with the high pressure compressor 128. As will be appreciated, the high pressure compressor 128, the combustor 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138. In this regard, the low pressure turbine 134 is drivingly coupled with the low pressure compressor 126 and components of the fan section 150. The LP shaft 138 is coaxial with the HP shaft 136 in this example embodiment. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a second stream.

The fan section 150 includes a variable pitch primary fan 152. For the depicted embodiment of FIG. 1, the primary fan 152 is an open rotor or unducted fan 152. In such a manner, the engine 100 may be referred to as an “open rotor engine.”

As depicted, the primary fan 152 includes a disk 153, an array of fan blades 154 (only one of which is shown in FIG. 1) extending from the disk 153, and a front hub 157 covering the disk 153 to promote airflow through the fan blades 154. The disk 153, the fan blades 154, and the front hub 157 are rotatable about the longitudinal axis 112. As noted above, the primary fan 152 is drivingly coupled with the low pressure turbine 134 via the LP shaft 138. For the embodiment shown in FIG. 1, the primary fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112 and around the disk 153. Each fan blade 154 has a root and a tip and a span defined therebetween. Further, each fan blade 154 defines a fan blade tip radius R₁ along the radial direction R from the longitudinal axis 112 to the tip, and a hub radius (or inner radius) R₂ along the radial direction R from the longitudinal axis 112 to the base of each fan blade 154 (i.e., from the longitudinal axis 112 to a radial location where each fan blade 154 meets a front hub of the gas turbine engine 100 at a leading edge of the respective fan blade 154). As will be appreciated, a distance from the base of each fan blade 154 to a tip of the respective fan blade 154 is referred to as a span of the respective fan blade 154. Further, the primary fan 152, or rather each fan blade 154 of the primary fan 152, defines a fan radius ratio, RqR (which is also referred to as the primary fan radius ratio, RqR_{Prim.-Fan}), equal to R₂ divided by R₁. Moreover, each fan blade 154 defines a central blade axis 156.

The gas turbine engine 100 includes a pitch change mechanism (PCM) 158 configured to vary the pitch of one or more of the fan blades 154 about its respective central blade axis 156. The PCM 158 includes one or more hydraulic actuators that serve to vary the pitch of a corresponding fan blade 154. The PCM 158 rotates with the fan blades 154 relative to the central blade axis 156. For the embodiment shown in FIG. 1, each one of the fan blades 154 is rotatable about its central blade axis 156. In some embodiments, the PCM 158 can be configured to collectively vary the pitch of the fan blades 154 in unison. In some embodiments, the PCM 158 can be configured to vary the pitch of only a subset of the fan blades 154.

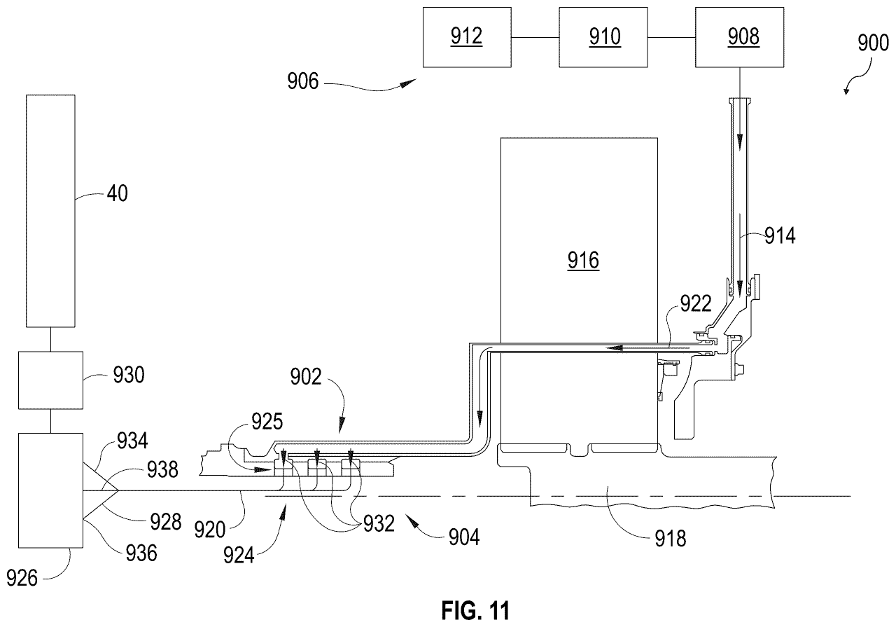

Hydraulic fluid must be supplied to the hydraulic actuators of the PCM 158 in order for the hydraulic actuators to operate. Accordingly, the gas turbine engine 100 further includes a fluid transfer system configured to supply hydraulic fluid to the one or more hydraulic actuators of the PCM 158. The fluid transfer system includes a stationary member fluidly coupled to a hydraulic fluid source and a rotatable member fluidly coupled to the PCM 158. The fluid transfer system transfers hydraulic fluid from the stationary member to the rotatable member, thereby beneficially allowing hydraulic fluid to be supplied from a reservoir that does not rotate with the fan blades 154 to the PCM 158 which rotates with the fan blades 154. In some embodiments, the fluid transfer system can be further configured to channel fluid through the gearbox 155. Various additional examples of fluid transfer systems for the gas turbine engine 100 are described below with respect to FIGS. 11-14. The fluid transfer systems disclosed herein exhibit several desirable advantages over conventional hydraulic fluid supply mechanisms (e.g., duplex bearings) that allow for increased performance (e.g., propulsive efficiency) of the gas turbine engine 100; for example, the disclosed fluid transfer systems are lighter weight, less complicated, and more cost-effective than duplex bearings.

In some embodiments, the fluid transfer system can additionally or alternatively supply a lubricating fluid to the PCM 158 and the primary fan 152. Lubricating fluid must be supplied to the PCM 158 in order for the PCM 158 to smoothly actuate.

The fan section 150 further includes a fan guide vane array 160 that includes fan guide vanes 162 (only one of which is shown in FIG. 1) disposed around the longitudinal axis 112. For this embodiment, the fan guide vanes 162 are not rotatable about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

As shown in FIG. 1, in addition to the primary fan 152, which is unducted, a ducted secondary fan 184 is included aft of the primary fan 152, such that the engine 100 includes both a ducted fan and an unducted fan which both serve to generate thrust through the movement of air without passage through at least a portion of the turbomachine 120 (e.g., without passage through the HP compressor 128 and combustion section for the embodiment depicted). The secondary fan 184 is rotatable about the same axis (e.g., the longitudinal axis 112) as the fan blades 154 of the primary fan 152. The secondary fan 184 is, for the embodiment depicted, driven by the low pressure turbine 134 (e.g., coupled to the LP shaft 138). It will be appreciated that, when used in connection with the fans 152, 184, the terms “primary” and “secondary” are terms of convenience, and do not imply any particular importance, power, or the like.

The ducted secondary fan 184 includes a plurality of fan blades (not separately labeled in FIG. 1; see fan blades 185 labeled in FIG. 2) arranged in a single stage, such that the secondary fan 184 may be referred to as a single stage fan. The fan blades of the secondary fan 184 can be arranged in equal spacing around the longitudinal axis 112. Each blade of the ducted secondary fan 184 has a root and a tip and a span defined therebetween. Further, each fan blade of the secondary fan 184 defines a fan blade tip radius R₃ along the radial direction R from the longitudinal axis 112 to the tip, and a hub radius (or inner radius) R₄ along the radial direction R from the longitudinal axis 112 to the base of the respective fan blades of the secondary fan 184 (i.e., a location where the respective fan blades of the secondary fan 184 meet an inner flowpath liner at a leading edge of the respective fan blades of the ducted secondary fan 184). As will be appreciated, a distance from the base of each fan blade of the secondary fan 184 to a tip of the respective fan blade is referred to as a span of the respective fan blade. Further, the secondary fan 184, or rather each fan blade of the secondary fan 184, defines a fan radius ratio, RqR, equal to R₄ divided by R₃. As the secondary fan 184 is the secondary fan of the engine 100, the fan radius ratio, RqR, of the secondary fan 184 may be referred to as the secondary fan radius ratio, RqR_{Sec.-Fan}.

The fan cowl 170 annularly encases at least a portion of the core cowl 122 and is generally positioned outward of at least a portion of the core cowl 122 along the radial direction R. Particularly, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one shown in FIG. 1). The stationary struts 174 may each be aerodynamically contoured to direct air flowing thereby. Other struts in addition to the stationary struts 174 may be used to connect and support the fan cowl 170 and/or core cowl 122. In some embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also defines or includes an inlet duct 180. The inlet duct 180 extends between an engine inlet 182 and the core inlet 124/fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split, not necessarily evenly, into the core duct 142 and the fan duct 172 by a fan duct splitter or leading edge 144 of the core cowl 122. The inlet duct 180 is wider than the core duct 142 along the radial direction R. The inlet duct 180 is also wider than the fan duct 172 along the radial direction R. The secondary fan 184 is positioned at least partially in the inlet duct 180.

Notably, for the embodiment depicted in FIG. 1, the engine 100 includes one or more features to increase an efficiency of a third stream thrust, Fn_{3S} (e.g., a thrust generated by an airflow through the fan duct 172 exiting through the fan exhaust nozzle 178, generated at least in part by the secondary fan 184). In particular, the engine 100 further includes an array of inlet guide vanes 186 positioned in the inlet duct 180 upstream of the secondary fan 184 and downstream of the engine inlet 182. The array of inlet guide vanes 186 are arranged around the longitudinal axis 112. For this embodiment, the inlet guide vanes 186 are not rotatable about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Further, located downstream of the secondary fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, for the embodiment depicted, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the secondary fan 184, the array of outlet guide vanes 190 located downstream of the secondary fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Moreover, referring still to FIG. 1, in some embodiments, air passing through the fan duct 172 may be relatively cooler (e.g., lower temperature) than one or more fluids utilized in the turbomachine 120. In this way, one or more heat exchangers 200 may be positioned in thermal communication with the fan duct 172. For example, one or more heat exchangers 200 may be disposed within the fan duct 172 and utilized to cool one or more fluids from the core engine with the air passing through the fan duct 172, as a resource for removing heat from a fluid, e.g., compressor bleed air, oil, or fuel.

The heat exchanger 200 may be an annular heat exchanger extending substantially 360 degrees in the fan duct 172 (e.g., at least 300 degrees, such as at least 330 degrees). In such a manner, the heat exchanger 200 may effectively utilize the air passing through the fan duct 172 to cool one or more systems of the engine 100 (e.g., lubrication oil systems, compressor bleed air, electrical components, etc.). The heat exchanger 200 uses the air passing through duct 172 as a heat sink and correspondingly increases the temperature of the air downstream of the heat exchanger 200 and exiting the fan exhaust nozzle 178.

Referring now to FIG. 2, a close-up, simplified, schematic view of the gas turbine engine 100 of FIG. 1 is provided. As noted above, the gas turbine engine 100 includes the variable pitch primary fan 152 having fan blades 154 and the ducted secondary fan 184 having fan blades 185. Airflow from the fan 152 is split between a bypass region 194 (as defined below) and the inlet duct 180 by an inlet splitter 196. Airflow from the ducted secondary fan 184 is split between the fan duct 172 and the core duct 142 by the leading edge 144 (sometimes also referred to as a fan duct splitter).

The exemplary gas turbine engine 100 depicted in FIG. 2 further defines a primary fan outer fan area, A_{P_Out}, a primary fan inner fan area, A_{P_In}, a secondary fan outer fan area, A_{S_Out}, and a secondary fan inner fan area, A_{S_In}.

The primary fan outer fan area, A_{P_Out}, refers to an area defined by an annulus representing a portion of the primary fan 152 located outward of the inlet splitter 196 of the fan cowl 170. In particular, the gas turbine engine 100 further defines a fan cowl splitter radius, R₅. The fan cowl splitter radius, R₅, is defined along the radial direction R from the longitudinal axis 112 to the inlet splitter 196. The primary fan outer fan area, A_{P_Out}, refers to an area defined by the formula:

$$π {R}_{1}^{2} - π {R}_{5}^{2} .$$

The primary fan inner fan area, A_{P_In}, refers to an area defined by an annulus representing a portion of the primary fan 152 located inward of the inlet splitter 196 of the fan cowl 170. In particular, the gas turbine engine 100 further defines an engine inlet inner radius, R₆. The engine inlet inner radius, R₆, is defined along the radial direction R from the longitudinal axis 112 to an inner casing defining the engine inlet 182 directly inward along the radial direction R from the inlet splitter 196. The primary fan inner fan area, A_{P_In}, refers to an area defined by the formula:

$$π {R}_{5}^{2} - π {R}_{6}^{2} .$$

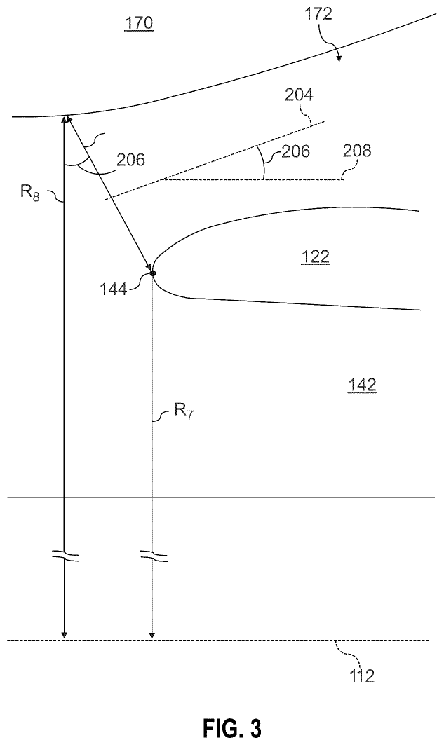

The secondary fan outer fan area, A_{S_Out}, refers to an area representing a portion of an airflow from the ducted fan 184 that is provided to the fan duct 172. In particular, the leading edge 144 defines a leading edge radius, R₇, and the gas turbine engine 100 defines an effective fan duct inlet outer radius, R₈ (see FIG. 3). The leading edge radius, R₇, is defined along the radial direction R from the longitudinal axis 112 to the leading edge 144.

Referring briefly to FIG. 3, providing a close-up view of an area surrounding the leading edge 144, the fan duct 172 defines a cross-wise height 198 measured from the leading edge 144 to the fan cowl 170 in a direction perpendicular to a mean flow direction 204 of an airflow through a forward 10% of the fan duct 172. An angle 206 is defined by the mean flow direction 204 relative to a reference line 208 extending parallel to the longitudinal axis 112. The angle 206 is referred to as 0. In certain embodiments, the angle 206 may be between 5 degrees and 80 degrees, such as between 10 degrees and 60 degrees (an increased angle is a counterclockwise rotation in FIG. 3). The effective fan duct inlet outer radius, R₈, is defined along the radial direction R from the longitudinal axis 112 to where the cross-wise height 198 meets the fan cowl 170. The secondary fan outer fan area, A_{S_Out}, refers to an area defined by the formula:

$$\frac{π ( {R}_{8}^{2} - {R}_{7}^{2} )}{cos ( θ )}$$

Referring back to FIG. 2, the secondary fan inner fan area, A_{S_In}, refers to an area defined by an annulus representing a portion of the ducted secondary fan 184 located inward of the leading edge 144 of the core cowl 122. In particular, the gas turbine engine 100 further defines a core inlet inner radius, R₉. The core inlet inner radius, R₉, is defined along the radial direction R from the longitudinal axis 112 to an inner casing defining the core inlet 124 directly inward along the radial direction R from the leading edge 144. The secondary fan inner fan area, A_{S_In}, refers to an area defined by the formula:

$$π {R}_{7}^{2} - π {R}_{9}^{2} .$$

The primary fan outer fan area, A_{P_Out}, the primary fan inner fan area, A_{P_In}, the secondary fan outer fan area, A_{S_Out}, and the secondary fan inner fan area, A_{S_In}, may be used in defining various airflow ratios for the engine 100. In particular, it will be appreciated that the exemplary engine 100 of FIGS. 1 through 3 further defines a thrust to power airflow ratio and a core bypass ratio, which as discussed herein are used to define an engine in accordance with the present disclosure. The thrust to power airflow ratio is a ratio of an airflow through the bypass passage of the engine 100 and through the fan duct 172 to an airflow through the core duct 142. The bypass passage (not separately labeled) is located within the bypass region 194 and refers to a passage where airflow from the primary fan 152 passes over the inlet duct 180. Further, the core bypass ratio is a ratio of an airflow through the fan duct 172 to the airflow through the core duct 142. These ratios are calculated while the engine 100 is operating at a rated speed during standard day operating conditions, and the amounts of airflow used to calculate these ratios are each expressed as a mass flowrate in the same units (mass per unit time).

More specifically, the amount of airflow through the engine's bypass passage can be determined using a fan pressure ratio for the primary fan 152, a rotational speed of the primary fan 152, or both while the engine is operating at the rated speed during standard day operating conditions, and the primary fan outer fan area, A_{P_Out}. The amount of airflow through the inlet duct 180 can be determined using a fan pressure ratio for the primary fan 152, a rotational speed of the primary fan 152, or both while operating at a rated speed during standard day operating conditions, and the primary fan inner fan area, A_{P_In}. The amount of airflow through the fan duct 172 and the amount of airflow through the core duct 142 can be determined based on the amount of airflow through the inlet duct 180 while the engine is operating at the rated speed during standard day operating conditions; a fan pressure ratio, a rotational speed, or both of the secondary fan 184 while the engine is operating at the rated speed during standard day operating conditions; and the secondary fan outer fan area, A_{S_Out}, and the secondary fan inner fan area, A_{S_In}.

As alluded to earlier, the inventors discovered, unexpectedly during the course of gas turbine engine design—i.e., designing gas turbine engines (e.g., both ducted and unducted gas turbine engines and turboprop engines) having a variety of different primary fan and secondary fan characteristics- and evaluating an overall propulsive efficiency, significant relationships exist in a ratio of an airflow through a bypass passage and through a third stream to an airflow through a core duct (referred to herein as a thrust to power airflow ratio), as well as in a ratio of an airflow through the third steam to the airflow through the core duct (referred to herein as a core bypass ratio). These relationships can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

As will be appreciated, it may generally be desirable to increase a fan diameter in order to provide a higher thrust to power airflow ratio, which typically correlates to a higher overall propulsive efficiency. However, increasing the fan diameter too much may actually result in a decrease in propulsive efficiency at higher speeds due to a drag from the fan blades. Further, increasing the fan diameter too much may also create prohibitively heavy fan blades, creating installation problems due to the resulting forces on the supporting structure (e.g., frames, pylons, etc.), exacerbated by a need to space the engine having such fan blades further from a mounting location on the aircraft to allow the engine to fit, e.g., under/over the wing, adjacent to the fuselage, etc.

Similarly, it may generally be desirable to increase an airflow through the fan duct relative to the core duct in order to provide a higher core bypass ratio, as such may also generally correlate to a higher overall propulsive efficiency. Notably, however, the higher the core bypass ratio, the less airflow provided to the core of the gas turbine engine. For a given amount of power needed to drive, e.g., a primary fan and a secondary fan of the gas turbine engine, if less airflow is provided, either a maximum temperature of the core needs to be increased or a size of the primary fan or secondary fan needs to be decreased. Such a result can lead to either premature wear of the core or a reduction in propulsive efficiency of the gas turbine engine.

As noted above, the inventors of the present disclosure discovered bounding the relationships defined by the thrust to power airflow ratio and core bypass ratio can result in a gas turbine engine maintaining or even improving upon a desired propulsive efficiency, while also taking into account the gas turbine engine's packaging concerns and weight concerns, and also providing desired thermal management capabilities. The relationship discovered, infra, can identify an improved engine configuration suited for a particular mission requirement, one that takes into account installation, packaging and loading, thermal sink needs and other factors influencing the optimal choice for an engine configuration.

In addition to yielding an improved gas turbine engine, as explained in detail above, utilizing this relationship, the inventors found that the number of suitable or feasible gas turbine engine designs incorporating a primary fan and a secondary fan, and defining a third stream, capable of meeting both the propulsive efficiency requirements and packaging, weight, and thermal sink requirements could be greatly diminished, thereby facilitating a more rapid down selection of designs to consider as a gas turbine engine is being developed. Such a benefit provides more insight to the requirements for a given gas turbine engine well before specific technologies, integration and system requirements are developed fully. Such a benefit avoids late-stage redesign.

The desired relationships providing for the improved gas turbine engine, discovered by the inventors, are expressed as:

$$TPAR = ( {A}_{B} + {A}_{3 S} ) / {A}_{C} \qquad ( 1 )$$

$$CBR = {A}_{3 S} / {A}_{C} \qquad ( 2 )$$

where TPAR is a thrust to power airflow ratio, CBR is a core bypass ratio, AB is an airflow through a bypass passage of the gas turbine engine while the engine is operated at a rated speed during standard day operating conditions, A_{3S} is an airflow through a third stream of the gas turbine engine while the engine is operated at the rated speed during standard day operating conditions, and Ac is an airflow through a core of the gas turbine engine while the engine is operated at the rated speed during standard day operating conditions. The airflow through the core of the gas turbine engine may refer to an airflow through an upstream end of the core (e.g., an airflow through a first stage of a high pressure compressor of the core). A_{B}, A_{3S}, and A_{C} are each expressed as mass flowrate, with the same units as one another.

Values for various parameters of the influencing characteristics of an engine defined by Expressions (1) and (2) are set forth below in TABLE 1:

TABLE 1

| | | Ranges appropriate for using |
|---|---|---|
| Symbol | Description | Expression (1) |
| R₁/R₃ | Tip radius ratio | 1.35 to 10, such as 2 to 7, such |
| | | as 3 to 5, such as at least 3.5, |
| | | such as at least 3.7, such as at |
| | | least 4, such as up to 10, such |
| | | as up to 7 |
| RqR_{Sec.-Fan} | Secondary fan | 0.2 to 0.9, such as 0.2 to 0.7, |
| | radius ratio | such as 0.57 to 0.67 |
| RqR_{Prim.-Fan} | Primary fan radius | 0.2 to 0.4, such as 0.25 to 0.35 |
| | ratio | |
| TPAR | Thrust to power | 3.5 to 100, such as 4 to 75 |
| | airflow ratio | (see also, TABLE 2, below) |
| CBR | Core Bypass Ratio | 0.1 to 10, such as 0.3 to 5 |
| | | (see also, TABLE 2, below) |

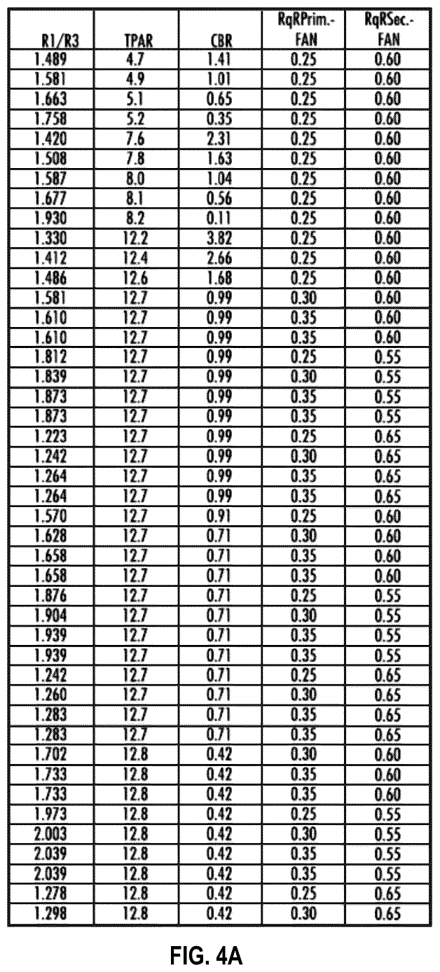

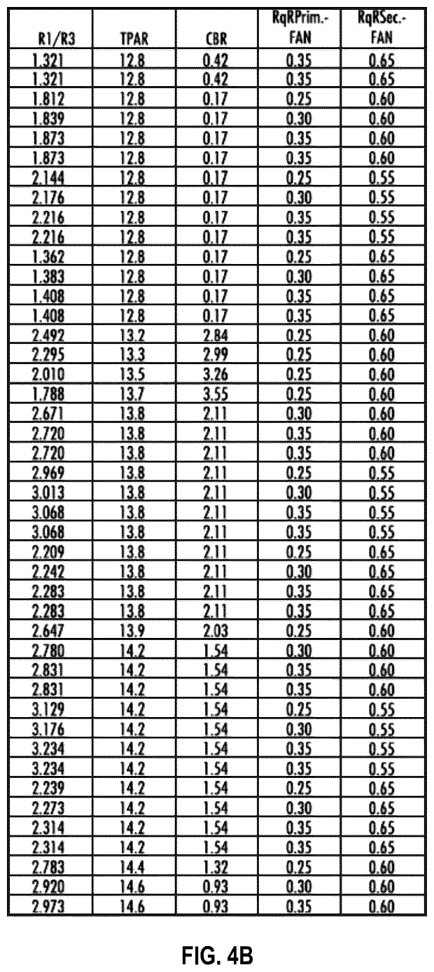

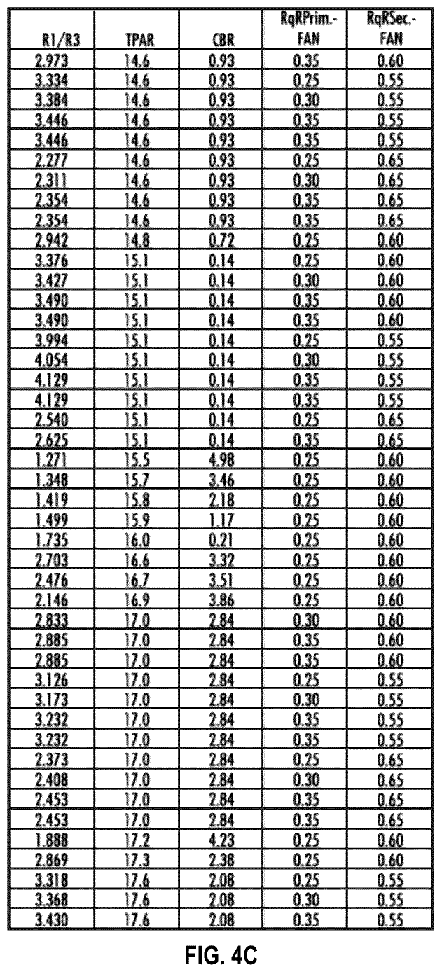

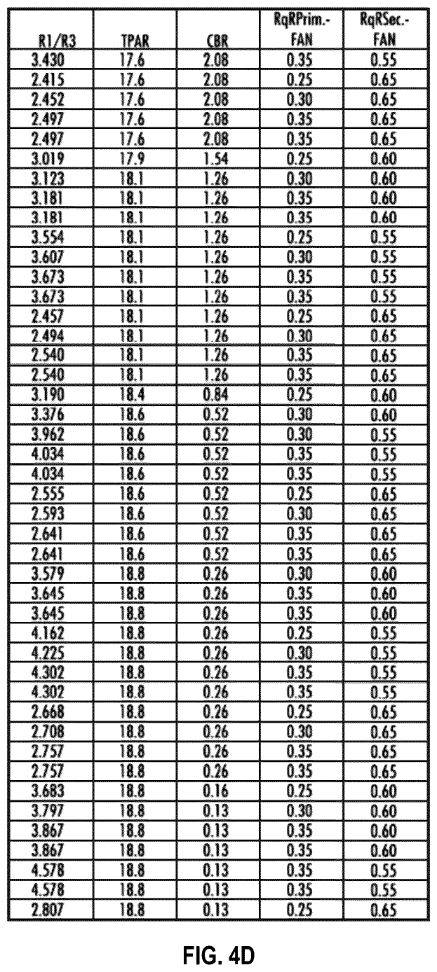

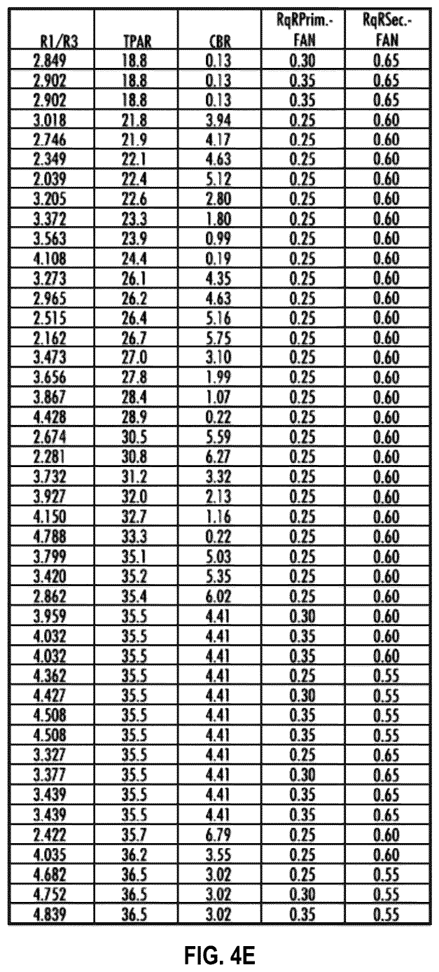

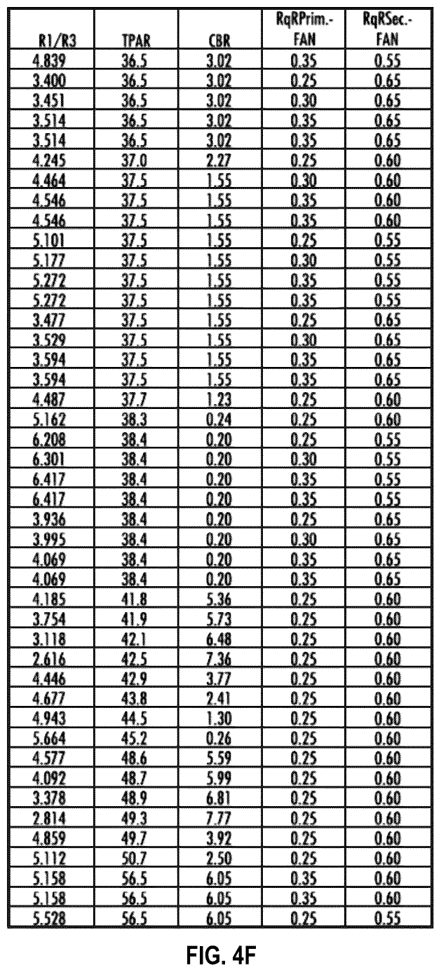

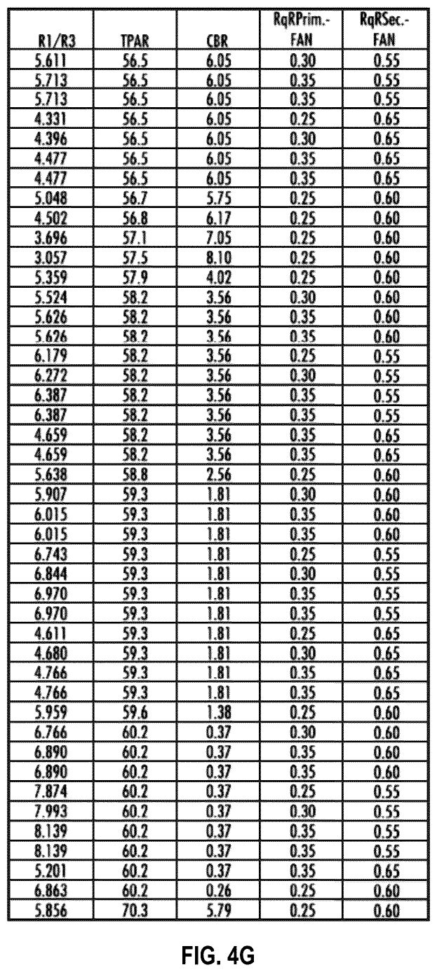

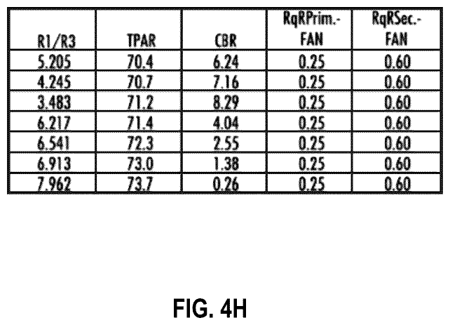

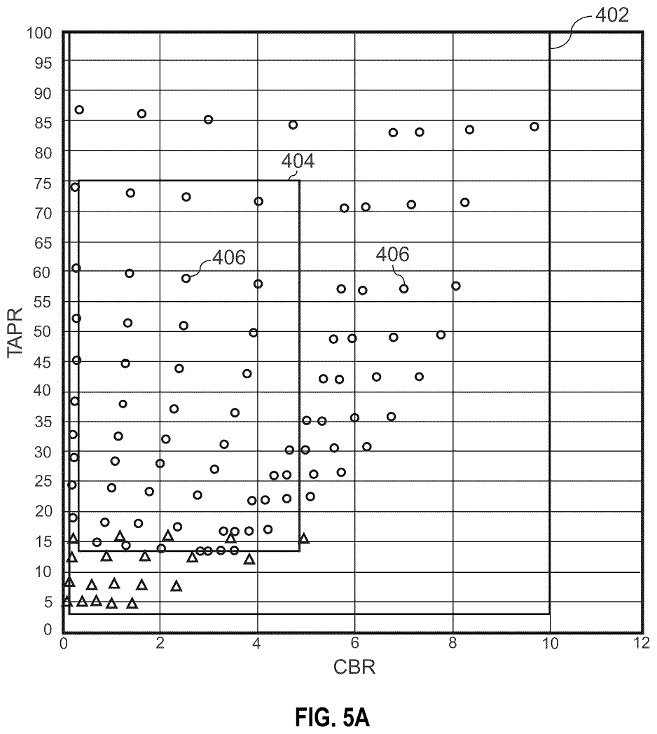

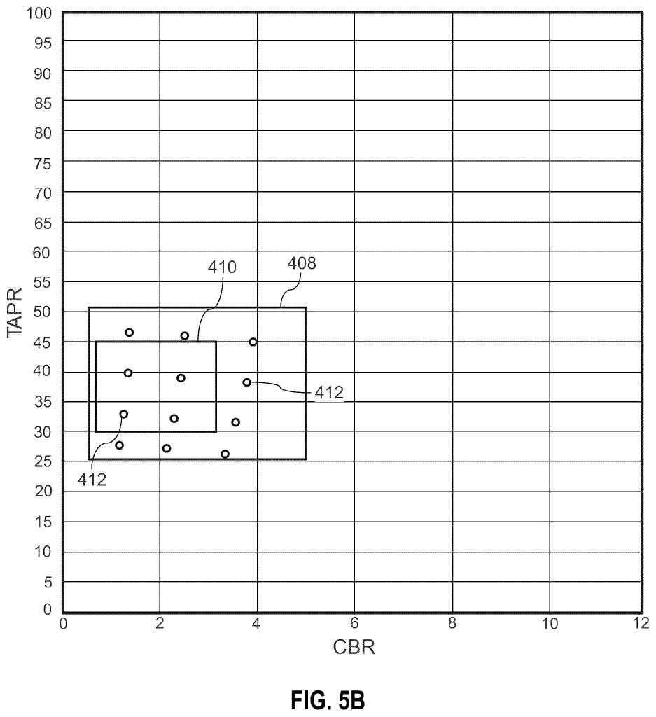

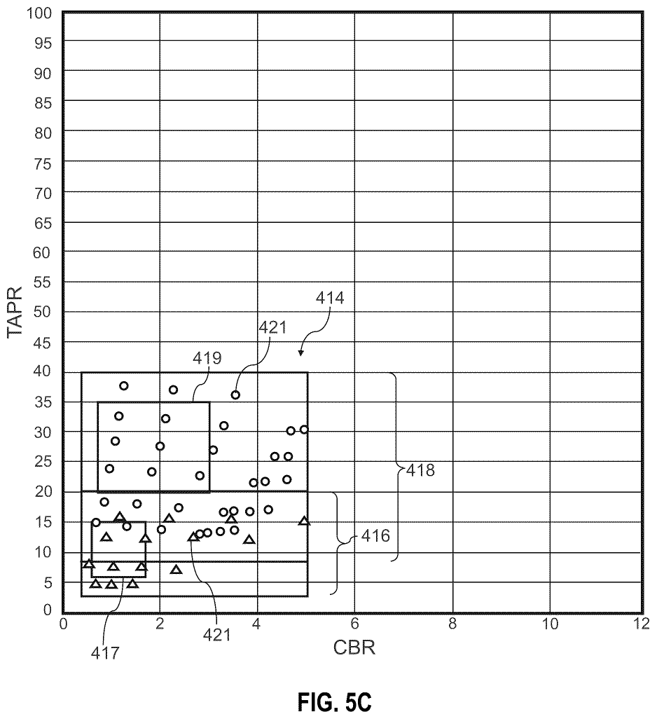

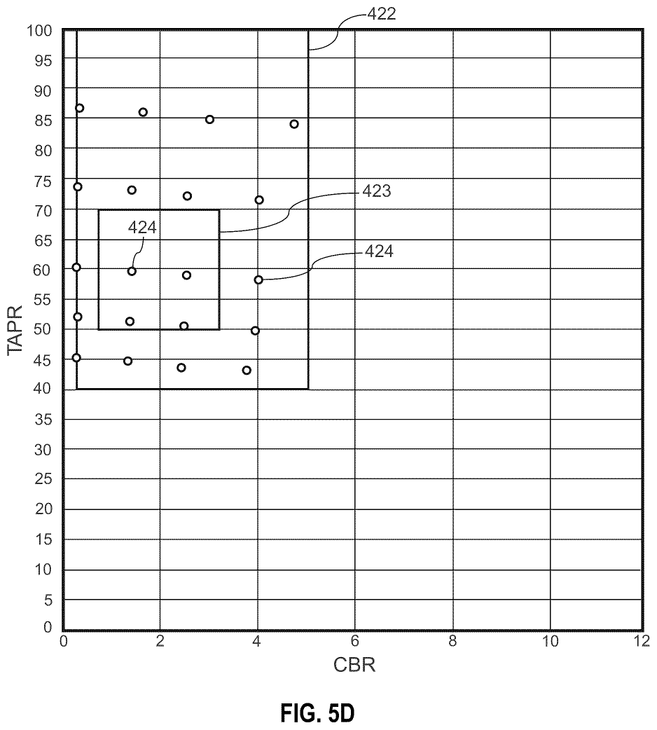

Referring now to FIGS. 4A through 4H and 5A through 5D, the relationships between the various parameters of Expressions (1) and (2) of exemplary gas turbine engines are illustrated in accordance with one or more exemplary embodiments of the present disclosure. In particular, FIGS. 4A through 4H provide a table including numerical values corresponding to several of the plotted gas turbine engines in FIGS. 5A through 5D. FIGS. 5A through 5D are plots of gas turbine engines in accordance with one or more exemplary embodiments of the present disclosure, showing the TPAR (Y-Axis) and the CBR (X-axis). FIGS. 5A through 5D highlight preferred subranges, including subranges for unducted engines, ducted engines, and turboprop engines, as discussed hereinbelow.

Referring particularly to FIG. 5A, a first range 402 and a second range 404 are provided, and exemplary embodiments 406 are plotted. The exemplary embodiments 406 include a variety of gas turbine engine types in accordance with aspects of the present disclosure, including unducted gas turbine engines, ducted gas turbine engines (which are also referred to herein as “turbofan engines”), and turboprop engines. The first range 402 corresponds to a TPAR between 3.5 and 100 and a CBR between 0.1 and 10. The first range 402 captures the benefits of the present disclosure across the variety of engine types. The second range 404 corresponds to a TPAR between 14 and 75 and a CBR between 0.3 and 5. The second range 404 may provide more desirable TPAR and CBR relationships across the variety of engine types to achieve propulsive efficiency, while still providing packaging and weight benefits, thermal benefits, etc.

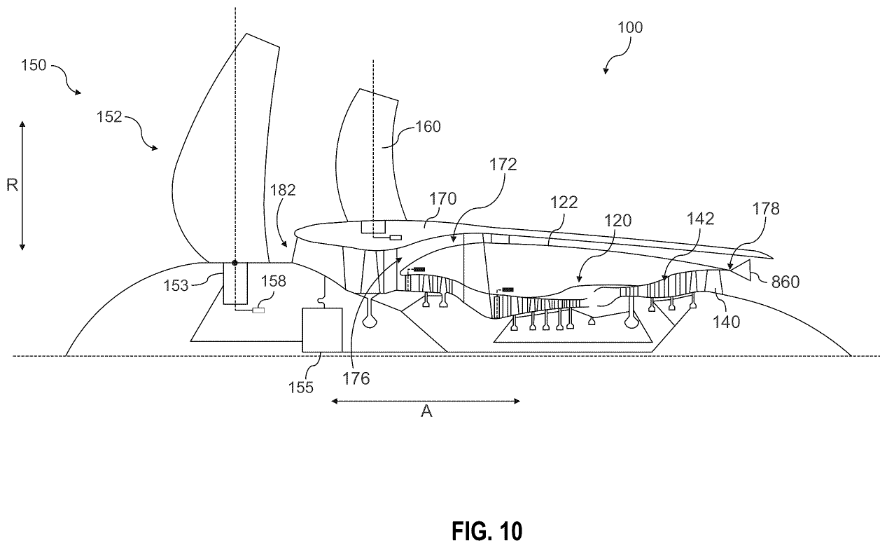

Referring particularly to FIG. 5B, a third range 408 and a fourth range 410 are provided, and exemplary embodiments 412 are plotted. The exemplary embodiments 412 include a variety of unducted gas turbine engines in accordance with aspects of the present disclosure. In particular, the exemplary embodiments 412 include a variety of gas turbine engines having an unducted primary fan, similar to the exemplary embodiments described herein with reference to FIGS. 1 and 10. The third range 408 corresponds to a TPAR between 30 and 56 and a CBR between 0.3 and 5. The third range 408 captures the benefits of the present disclosure for unducted gas turbine engines. The fourth range 410 corresponds to a TPAR between 35 and 50 and a CBR between 0.5 and 3. The fourth range 410 may provide more desirable TPAR and CBR relationships for the unducted gas turbine engines to achieve propulsive efficiency, while still providing packaging and weight benefits, thermal benefits, etc.

As will be appreciated, the unducted gas turbine engines may have, on the whole, a higher TPAR as compared to the ducted gas turbine engines (see FIG. 5C), enabled by a lack of an outer nacelle or other casing surrounding a primary fan. The range of CBR values in the fourth range 410 isn't as large as the range of CBR values in the third range 408, as in the embodiments with a higher TPAR, the CBR needs to be lower to provide a necessary amount of airflow to a core of the engine without exceeding temperature thresholds or requiring an undesired reduction in a size of the primary fan.

The inventors of the present disclosure have found that the TPAR values and CBR values in the third and fourth ranges 408, 410 shown may provide a desirable propulsive benefit, while still enabling operation of the core in a reasonable manner, and balancing installation and thermal load considerations.

Referring particularly to FIG. 5C, a fifth range 414, a sixth range 416, a seventh range 417, an eighth range 418, and a ninth range 419 are provided, and exemplary embodiments 421 are plotted. The exemplary embodiments 421 include a variety of ducted gas turbine engines in accordance with aspects of the present disclosure. In particular, the exemplary embodiments 421 include a variety of gas turbine engines having a ducted primary fan, similar to the exemplary embodiments described herein with reference to FIGS. 7 through 9. The fifth range 414 corresponds to a TPAR between 3.5 and 40 and a CBR between 0.3 and 5. The fifth range 414 captures the benefits of the present disclosure for ducted gas turbine engines.

The sixth range 416 corresponds to a TPAR between 3.5 and 20 and a CBR between 0.2 and 5. The sixth range 416 captures the benefits of the present disclosure for ducted gas turbine engines in a direct drive configuration (see, e.g., FIG. 7). As will be appreciated, with a ducted, direct drive gas turbine engine a primary fan may be smaller, limiting a TPAR. The seventh range 417, which also corresponds to ducted gas turbine engines in a direct drive configuration, corresponds to a TPAR between 6 and 15 and a CBR between 0.3 and 1.8, and may represent a more preferrable range.

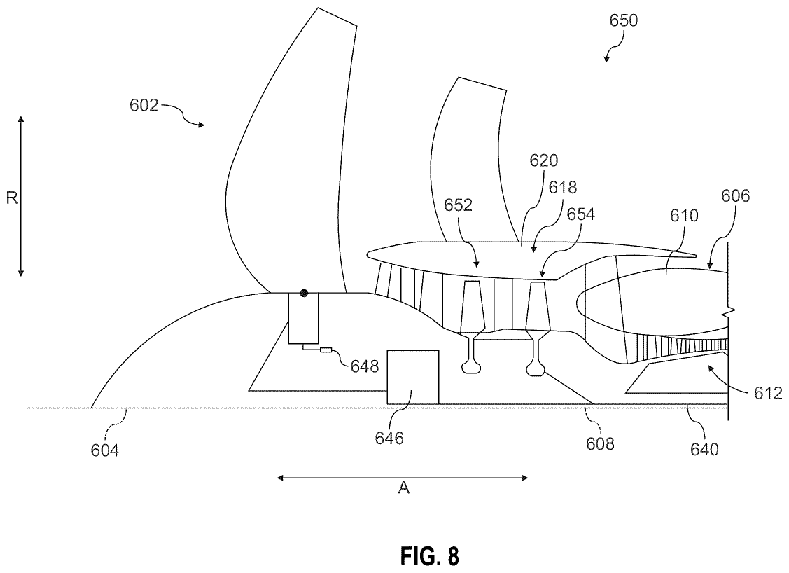

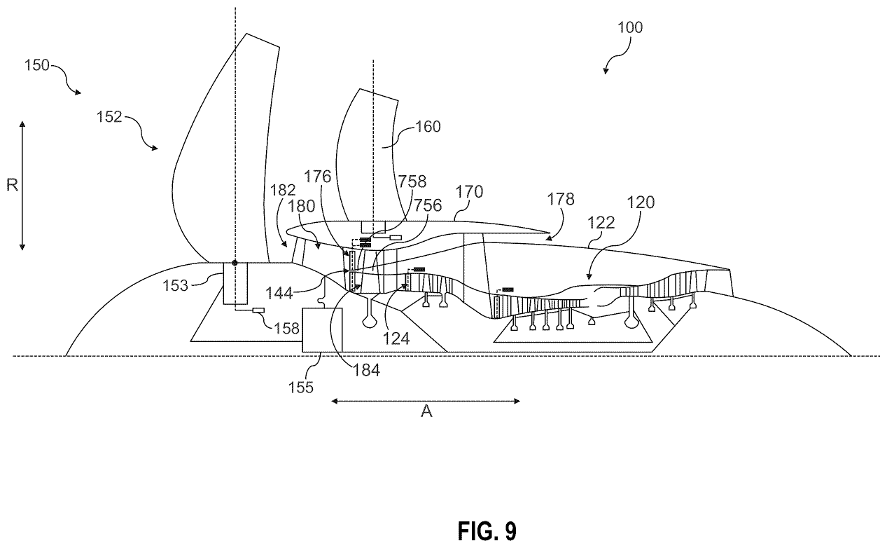

The eighth range 418 corresponds to a TPAR between 8 and 40 and a CBR between 0.2 and 5. The eighth range 418 captures the benefits of the present disclosure for ducted gas turbine engines in a geared configuration (see, e.g., FIGS. 8 and 9). As will be appreciated, with a ducted, geared gas turbine engine a primary fan may be larger as compared to a ducted, direct drive gas turbine engine, allowing for a larger TPAR. TPAR is, in turn limited by an allowable nacelle drag and fan operability.

The ninth range 419 corresponds to ducted gas turbine engines in a geared configuration having a variable pitch primary fan, e.g., the primary fan 152. The ninth range 419 corresponds to a TPAR between 20 and 35 and a CBR between 0.5 and 3. It will be appreciated that in other exemplary aspects, a gas turbine engine of the present disclosure in a ducted, geared, variable pitch configuration may have TPAR between 15 and 40 and a CBR between 0.3 and 5.

As will be appreciated, the ducted gas turbine engines may have, on the whole, a lower TPAR than the unducted gas turbine engines as a result of an outer nacelle surrounding a primary fan (the outer nacelle becoming prohibitively heavy with higher diameter primary fans). The range of CBR values may generally be relatively high given the relatively low TPAR values (since a relatively high amount of airflow is provided to a secondary fan through an engine inlet when the TPAR values are low), as a necessary amount of airflow to a core of the ducted gas turbine engine may still be provided with a relatively high CBR without exceeding temperature thresholds or requiring a reduction in a size of the primary fan.

The inventors of the present disclosure have found that the TPAR values and CBR values in the fifth, sixth, seventh, eighth, and ninth ranges 414, 416, 417, 418, 419 shown may provide a desirable propulsive benefit, while still enabling operation of the core in a reasonable manner, and balancing installation and thermal load considerations.

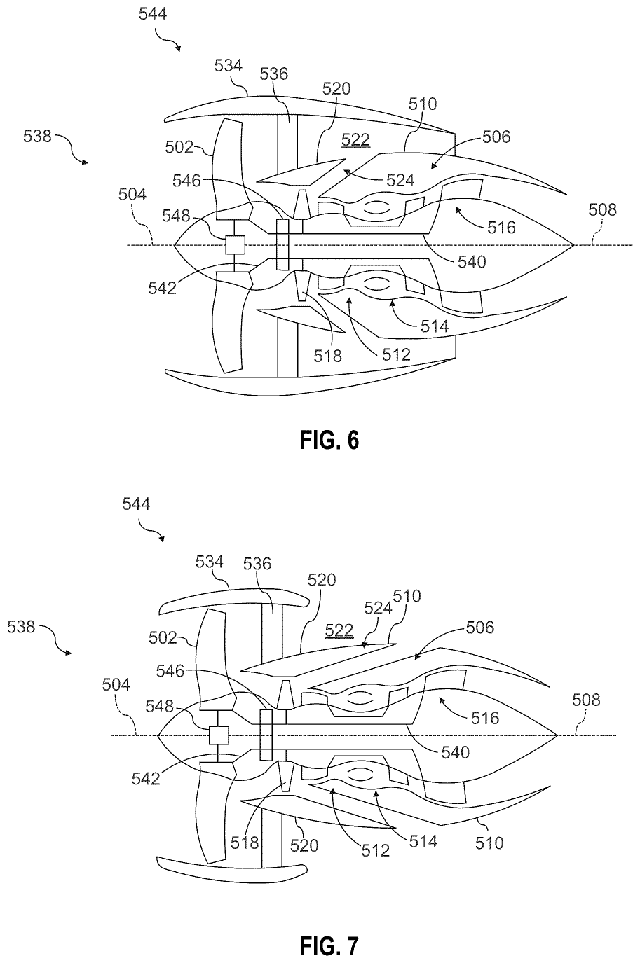

Referring particularly to FIG. 5D, a tenth range 422 and an eleventh range 423 are provided, and exemplary embodiments 424 are plotted. The exemplary embodiments 424 include a variety of turboprop gas turbine engines in accordance with aspects of the present disclosure. In particular, the exemplary embodiments 424 include a variety of turboprop gas turbine engine similar to the exemplary embodiment described herein with reference to FIG. 6. The tenth range 422 corresponds to a TPAR between 40 and 100 and a CBR between 0.3 and 5. The tenth range 422 captures the benefits of the present disclosure for turboprop gas turbine engines. The eleventh range 423 corresponds to a TPAR between 50 and 70 and a CBR between 0.5 and 3, and may represent a more preferrable range.

As will be appreciated, the turboprop gas turbine engines may have, on the whole, higher TPAR values than turbofan engines, enabled by the lack of an outer nacelle or other casing surrounding a primary fan and a relatively slow operational speed of the primary fan and aircraft incorporating the turboprop gas turbine engine. The range of CBR values in the tenth range 422 and the eleventh range 423 may be relatively small, as less air may be provided through a third stream with such a high TPAR without compromising operation of a core of the gas turbine engine.

The inventors of the present disclosure have found that the TPAR values and CBR values in the tenth range 422 and eleventh range 423 shown may provide a desirable propulsive benefit, while still enabling operation of the core in a reasonable manner, and balancing installation and thermal load considerations.

TABLE 2, below provides a summary of TPAR values and CBR values for various gas turbine engines in accordance with one or more exemplary aspects of the present disclosure.

TABLE 2

| Engine Type | TPAR Value | CBR Value |
|---|---|---|
| All Aeronautical Gas Turbine Engines | 3.5 to 100 | 0.1 to 10 |
| (“GTE”) | | |
| All Aeronautical GTE | 4 to 75 | 0.3 to 5 |
| Open Rotor GTE | 30 to 60 | 0.3 to 5 |
| Open Rotor GTE | 35 to 50 | 0.5 to 3 |
| Ducted Gas GTE | 3.5 to 40 | 0.2 to 5 |
| Ducted, Geared GTE | 8 to 40 | 0.2 to 5 |
| Ducted, Geared, Variable Pitch GTE | 15 to 40 | 0.3 to 5 |
| Ducted, Geared, Variable Pitch GTE | 20 to 35 | 0.5 to 3 |
| Ducted, Geared, Fixed-Pitch GTE | 8 to 25 | 0.2 to 5 |
| Ducted, Geared, Fixed-Pitch GTE | 10 to 20 | 0.3 to 2 |
| Ducted, Direct Drive GTE | 3.5 to 20 | 0.2 to 5 |
| Ducted, Direct Drive GTE (lower flight | 6 to 20 | 0.2 to 5 |
| speed) | | |
| Ducted, Direct Drive GTE (lower flight | 8 to 15 | 0.3 to 1.8 |
| speed) | | |
| Ducted, Direct Drive GTE (higher flight | 3.5 to 10 | 0.2 to 2 |
| speed) | | |
| Ducted, Direct Drive GTE (higher flight | 3.5 to 6 | 0.3 to 1.5 |
| speed) | | |
| Turboprop GTE | 40 to 100 | 0.3 to 5 |
| Turboprop GTE | 50 to 70 | 0.5 to 3 |

For the purposes of Table 2, the term “ducted” refers to inclusion of an outer nacelle around a primary fan; “open rotor” refers to inclusion of an unducted primary fan; “geared” refers to inclusion of a reduction gearbox between the primary fan and a driving turbine; “direct drive” refers to exclusion of a reduction gearbox between the primary fan and a driving turbine; “variable pitch” refers to inclusion of a pitch change mechanism for changing a pitch of fan blades on a primary fan; “lower flight speed” refers to an engine designed to operate at a flight speed less than 0.85 Mach; and “higher flight speed” refers to an engine designed to operate at a flight speed higher than 0.85 Mach.

It will be appreciated that although the discussion above is generally relating to the open rotor engine 100 described above with reference to FIGS. 1 and 2, in various embodiments of the present disclosure, the relationships outlined above with respect to, e.g., Expressions (1) and (2) may be applied to any other suitable engine architecture. For example, reference will now be made to FIGS. 6 through 10, each depicting schematically an engine architecture associated with the present disclosure.

Now referring to FIGS. 6 and 7, each gas turbine engine 544 depicted by these figures generally include a variable pitch fan 502 rotatable about an axis 504 and a turbomachine 506 rotatable about a longitudinal axis 508. The variable pitch fan 502 corresponds to the “variable pitch primary fan” previously described herein (e.g., primary fan 152). The turbomachine 506 is surrounded at least in part by a core cowl 510 and includes a compressor section 512, a combustion section 514, and a turbine section 516 in serial flow order. In addition to the variable pitch fan 502, the gas turbine engines 544 of FIGS. 6 through 7 each also include a ducted mid-fan or secondary fan 518. The gas turbine engines each include a fan cowl 520 surrounding the secondary fan 518.

Referring still to FIGS. 6 and 7, the illustrated gas turbine engines 544 also define a bypass passage 522 downstream of the respective variable pitch fan 502 and over the respective fan cowl 520 and core cowl 510, and further define a third stream 524 extending from a location downstream of the respective secondary fan 518 to the respective bypass passage 522 (at least in the embodiments depicted; in other embodiments, the third stream 524 may instead extend to a location downstream of the bypass passage 522).

Referring still to FIGS. 6 and 7, the gas turbine engines 544 are each configured as turbofan engines, and more specifically as geared, ducted turbofan engines. In such a manner, the gas turbine engines 544 each include an outer nacelle 534 surrounding the variable pitch fan 502, and the variable pitch fan 502 (or variable pitch primary fan) of each is therefore configured as a ducted fan similar to the variable pitch primary fan 152. Further, each of the gas turbine engines 544 includes outlet guide vanes 536 extending through the bypass passage 522 to the outer nacelle 534 from the fan cowl 520, the core cowl 510, or both.

Now referring to FIG. 6, the geared, ducted, turbofan engine 544 includes the engine shaft 540 driven by the turbine section 516 and the fan shaft 542 rotatable with the variable pitch fan 502. The exemplary geared, ducted, turbofan engine 544 further includes a gearbox 546 mechanically coupling the engine shaft 540 to the fan shaft 542. The gearbox 546 allows the variable pitch primary fan 502 to rotate at a slower speed than the engine shaft 540, and thus at a slower speed than the secondary fan 518.

The exemplary geared, ducted, turbofan engine 544 of FIG. 6 further includes a pitch change mechanism 548 operable with the variable pitch fan 502 to change a pitch of the rotor blades of the variable pitch fan 502, allowing for an increased propulsive efficiency of the gas turbine engine 544. The turbofan engine 544 further includes a fluid transfer system for supplying a fluid (e.g., a hydraulic fluid, a lubricant) to the pitch change mechanism 548. Example fluid transfer systems compatible with the pitch change mechanism 548 and the turbofan engine 544 are described with respect to FIGS. 11-14.

Further, the exemplary gas turbine engine of FIG. 7 is again configured as a direct drive, ducted, turbofan engine 544. However, by contrast to the embodiment of FIG. 6 where a fan duct outlet defined by the fan duct is upstream of a bypass passage outlet defined by the bypass passage, in the embodiment of FIG. 7, the fan duct outlet defined by the fan duct is downstream of the bypass passage outlet defined by the bypass passage.

Moreover, in other exemplary embodiments, other suitable gas turbine engines may be provided. For example, referring now to FIG. 8, a gas turbine engine in accordance with yet another exemplary embodiment of the present disclosure is provided. The exemplary gas turbine engine of FIG. 8 may be configured in a similar manner as the exemplary gas turbine engines described above with reference to FIGS. 6 and 7.

For example, the exemplary gas turbine engine of FIG. 8 includes a rotor 602 rotatable about a rotor axis 604 and a turbomachine 606 rotatable about a longitudinal axis 608. The rotor axis 604 and the longitudinal axis 608 are aligned in the embodiment of FIG. 8. The rotor 602 corresponds to the “primary fan” described herein, and thus is a variable pitch primary fan coupled to a pitch change mechanism 648. The pitch change mechanism 648 is coupled to a fluid transfer system for supplying a fluid (e.g., a hydraulic fluid, a lubricant) to the hydraulic actuators of the pitch change mechanism 648. Example fluid transfer systems are described later herein with respect to FIGS. 11-14.

The turbomachine 606 is surrounded at least in part by a core cowl 610 and includes a compressor section 612 (and, not shown, a combustion section and a turbine section in serial flow order with the compressor section 612). In addition to the rotor 602, the gas turbine engine also includes a ducted mid-fan or secondary fan 618 and a fan cowl 620 surrounding the secondary fan 618.

However, for the embodiment of FIG. 8, the gas turbine engine is configured as an unducted gas turbine engine 650 (see, e.g., FIG. 1), and the secondary fan 618 is not configured as a single stage fan (see secondary fan 184 of FIG. 1). Instead, for the embodiment of FIG. 8, the secondary fan 618 is configured as a multi-stage secondary fan, and more specifically still as a two-stage secondary fan having a total of two stages of rotating compressor rotor blades, and more specifically having a first stage 652 of secondary fan rotor blades and a second stage 654 of secondary fan rotor blades. Notably, with such a configuration, the turbomachine 606 does not include a separate low pressure compressor.

Additionally, in still other exemplary embodiments, the gas turbine engine may have other configurations. For example, referring now to FIG. 9, a gas turbine engine in accordance with yet another exemplary embodiment of the present disclosure is provided. The exemplary gas turbine engine of FIG. 9 may be configured in a similar manner as the exemplary gas turbine engines described above with reference to, e.g., FIGS. 1 through 3.

For example, the exemplary gas turbine engine of FIG. 9 includes a turbomachine 120 and a rotor assembly, also referred to a fan section 150, positioned upstream thereof. The engine 100 further includes a fan cowl 170 and a core cowl 122, the fan cowl 170 annularly encasing at least a portion of the core cowl 122 and generally positioned outward of at least a portion of the core cowl 122 along the radial direction R. Particularly, a downstream section of the fan cowl 170 extends over a forward portion of the core cowl 122 to define a fan duct flowpath, or simply fan duct 172. Incoming air may enter through the fan duct 172 through a fan duct inlet 176 and may exit through a fan exhaust nozzle 178 to produce propulsive thrust. The fan duct 172 extends from a leading edge 144 of the core cowl 122.

The engine 100 also defines an inlet duct 180. The inlet duct 180 extends between an engine inlet 182 and a core inlet 124. The engine inlet 182 is defined generally at the forward end of the fan cowl 170 and is positioned between a primary fan 152 of the fan section 150 and a fan guide vane array 160 along the axial direction A. The primary fan 152 includes a plurality of fan blades each extending from a disk 153 and coupled to a pitch change mechanism 158. The engine 100 further includes a ducted secondary fan 184 with a plurality of fan blades located at least partially in the inlet duct 180.

However, for the embodiment of FIG. 9, the core cowl 122 carries forward to an aft edge of the fan blades of the ducted fan 184 and the fan blades themselves include an integral splitter 756. This configuration is referred to as a “blade-on-blade configuration” where inner and outer blades are effectively superimposed upon one another and may be unitarily formed or otherwise fabricated to achieve the split between streams.

The core cowl 122 further includes a section 758 extending forward past the fan blades of the secondary fan 184, such that the leading edge 144 is located forward of the fan blades of the secondary fan 184. With such an arrangement, the fan duct inlet 176 is also located forward of the fan blades of the secondary fan 184, and an outer portion of the fan blades along the radial direction R is positioned within the fan duct 172. With this configuration, a secondary fan outer fan area, A_{S_Out}, may be calculated at the fan duct inlet 176 in the same manner discussed above with reference to, e.g., FIGS. 2 and 3.

Further, with such a configuration, the secondary fan inner fan area, A_{S_In}, still refers to an area defined by an annulus representing a portion of the secondary fan 184 located inward of the leading edge 144 of the core cowl 122. However, a calculation of the secondary fan inner fan area, A_{S_In}, is based on a leading edge radius, R₇, of the leading edge 144 and an inner fan duct radius, defined along the radial direction R, directly inward along the radial direction R from the leading edge 144 (and not a core inlet inner radius at the core inlet 124).

Further, still, in other exemplary embodiments, other engine configurations may be provided. For example, referring now to FIG. 10, an engine 100 in accordance with another embodiment of the present disclosure is provided. The engine 100 of FIG. 10 may be configured in a similar manner as the exemplary engine 100 of, e.g., FIGS. 1 through 3.

For example, the exemplary gas turbine engine of FIG. 10 includes a turbomachine 120 and a rotor assembly, also referred to a fan section 150, positioned upstream thereof. The engine 100 further includes a fan cowl 170 and a core cowl 122, the fan cowl 170 annularly encasing at least a portion of the core cowl 122 and generally positioned outward of at least a portion of the core cowl 122 along the radial direction R. Particularly, a downstream section of the fan cowl 170 extends over a forward portion of the core cowl 122 to define a fan duct flowpath, or simply fan duct 172. Incoming air may enter through the fan duct 172 through a fan duct inlet 176 and may exit through a fan exhaust nozzle 178 to produce propulsive thrust. The fan duct 172 extends from a leading edge 144 of the core cowl 122.

However, for the embodiment of FIG. 10, the fan duct 172 of the exemplary engine 100 is an elongated fan duct 172 extending between the fan cowl 170 and the core cowl 122, a full length of the core cowl 122. With such a configuration, the fan exhaust nozzle 178 is downstream of an exhaust nozzle 140 of the turbomachine 120. The engine 100 of FIG. 10 further includes a mixing device 860 in the region aft of the exhaust nozzle 140 to aid in mixing airflow from the fan duct 172 and from a working gas flowpath 142 of the turbomachine 120, e.g., to improve acoustic performance by directing airflow from the working gas flowpath 142 of the turbomachine 120 outward and from the fan duct 172 inward. Mixing in such a manner may improve performance and noise emissions.

Moreover, in other exemplary embodiments of the present disclosure, a gas turbine engine may have still other suitable configurations. For example, in other embodiments, the gas turbine engine may include any suitable number of shafts or spools, compressors, or turbines (e.g., the gas turbine engine may be a three-spool engine having three turbines and associated spools).

Further, it will be appreciated that in at least certain exemplary embodiments of the present disclosure, a method of operating a gas turbine engine is provided. The method may be utilized with one or more of the exemplary gas turbine engines discussed herein, such as in FIGS. 1 through 10. The method includes operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5. For the exemplary method, the thrust to power airflow ratio is a ratio of an airflow through a bypass passage over a turbomachine of the gas turbine engine plus an airflow through a fan duct to an airflow through a core duct, and the core bypass ratio is a ratio of the airflow through the fan duct to the airflow through the core duct.

As will be appreciated from the description herein, various embodiments of a gas turbine engine are provided. Certain of these embodiments may be an unducted, single rotor gas turbine engine (see FIGS. 1 and 2, 9, and 10) or a ducted turbofan engine (see FIGS. 6 through 7). Another example of a ducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)). Various additional aspects of one or more of these embodiments are discussed below. These exemplary aspects may be combined with one or more of the exemplary gas turbine engine(s) discussed above with respect to the figures.

For example, in some embodiments of the present disclosure, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these embodiments, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

As such, it will be appreciated that an engine of such a configuration may be configured to generate at least 25,000 pounds and less than 80,000 of thrust during operation at a rated speed, such as between 25,000 and 50,000 pounds of thrust during operation at a rated speed, such as between 25,000 and 40,000 pounds of thrust during operation at a rated speed. Alternatively, in other exemplary aspects, an engine of the present disclosure may be configured to generate much less power, such as at least 2,000 pounds of thrust during operation at a rated speed.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter.

In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R₁/R₂ may be between 1 and 10, or 2 and 7, or at least 3.3, at least 3.5, at least 4 and less than or equal to 7, where R₁ is the radius of the primary fan and R₂ is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. Alternatively, in certain suitable embodiments, the engine allows for normal aircraft operation of at least Mach 0.3, such as with turboprop engines.

A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is between 3.0 and 4.0, between 3.2 and 3.5, or between 3.5 and 4.5. In some embodiments, a gear ratio of the input rotational speed to the output rotational speed is greater than 4.1. For example, in particular embodiments, the gear ratio is within a range of 4.0 to 4.5, within a range of 4.1 to 14.0, within a range of 4.5 to 14.0, or within a range of 6.0 to 14.0. In certain embodiments, the gear ratio is within a range of 4.5 to 12 or within a range of 6.0 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 4 to 15 stages, a high-pressure turbine may include 1 to 2 stages, and/or a low pressure turbine (LPT) may include 1 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

A core engine is generally encased in an outer casing defining one half of a core diameter (D_{core}), which may be thought of as the maximum extent from a centerline axis (datum for R). In certain embodiments, the engine includes a length (L) from a longitudinally (or axial) forward end to a longitudinally aft end. In various embodiments, the engine defines a ratio of L/D_{core} that provides for reduced installed drag. In one embodiment, L/D_{core} is at least 2. In another embodiment, L/D_{core} is at least 2.5. In some embodiments, the L/D_{core} is less than 5, less than 4, and less than 3. In various embodiments, it should be appreciated that the L/D_{core} is for a single unducted rotor engine.

The reduced installed drag may further provide for improved efficiency, such as improved specific fuel consumption. Additionally, or alternatively, the reduced installed drag may provide for cruise altitude engine and aircraft operation at the above describe Mach numbers at cruise altitude. Still particular embodiments may provide such benefits with reduced interaction noise between the blade assembly and the vane assembly and/or decreased overall noise generated by the engine by virtue of structures located in an annular duct of the engine.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above as an unshrouded or open rotor engine in the embodiments depicted above, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (D_{core}) of the engine, L/D_{core} of the engine, desired cruise altitude, and/or desired operating cruise speed, or combinations thereof.

FIG. 11 is a side view of a portion of a fluid transfer system 900, in accordance with still another exemplary aspect of the present disclosure. The fluid transfer system 900 is configured to supply a fluid (e.g., a hydraulic fluid, a lubricant) to the pitch change mechanism of a variable pitch fan. For example, the fluid transfer system 900 can be configured to supply hydraulic fluid to one or more hydraulic actuators of the pitch change mechanism, thereby enabling the hydraulic actuators to operate. The fluid transfer system 900 can be used to supply fluid to any pitch change mechanism (e.g., any of PCMs 158, 648, 648) of variable pitch fan (e.g., any of fans 152, 502, 602) of any gas turbine engine disclosed herein (e.g., any of gas turbine engines 100, 544, 650).

The fluid transfer system 900 is configured to transfer a flow of fluid (a “fluid flow”) from a stationary member 902 to an adjacent rotatable member 904. In some embodiments, the fluid transfer system 900 includes a source 906 of the fluid flow that includes a fluid reservoir 908, a controllable pump 910, and a controllable valve 912. The fluid transfer system 900 additionally includes one or more fluid supply conduits 914 configured to channel the fluid flow to a power gearbox 916. The power gearbox 916 (which can be similar to any one of gearboxes 155, 546, 646) is configured to transform rotational energy from a first power shaft 918 918 (which can be similar to any one of shafts 138, 540, 640) rotating at a first speed into rotational energy in a second load shaft 920 rotating at a second speed. In some embodiments, the power gearbox 916 is also configured to channel the fluid flow through the power gearbox 916 through a gearbox flow path 922. In some embodiments, when power gearbox 916 is of a star configuration a planetary gear carrier is held stationary, permitting channeling the flow of fluid through planetary gear carrier of power gearbox 916. However, in some embodiments where the power gearbox 916 is of a planetary configuration, the planetary gear carrier is also rotatable making routing of the flid flow through power gearbox 916 difficult. In such embodiments, the fluid flow may be routed around the power gearbox 916. The fluid transfer system 900 further includes a transfer sleeve device 924 configured to receive the fluid flow from the gearbox flow path 922. The transfer sleeve device 224 includes stationary member 902 (which is also referred to herein as “a stationary transfer sleeve member”) and rotatable member 904 (which is also referred to herein as “a rotatable transfer sleeve member”). The transfer sleeve device 924 is configured to transfer the flows of fluid between the stationary transfer sleeve member 902 and the rotatable transfer sleeve member 904 across a gap 925 formed between the stationary transfer sleeve member 902 and the rotatable transfer sleeve member 904. The fluid transfer system 900 also includes or is fluidly coupled to a pitch change mechanism (PCM) 926 (which can be similar to any one of pitch change mechanisms 158, 548, 648), which is configured to receive fluid flow through one or more of a plurality of flow ports 928. The plurality of flow ports 928 are configured to direct the fluid flow to a respective PCM actuator 930 of the PCM 926. In some embodiments, transfer sleeve device 924 can be formed integrally with power gearbox 916. In other embodiments, the transfer sleeve device 924 is formed on a forward end of the power gearbox 916 or on an aft end of the power gearbox 916. The transfer sleeve device 924 is configured to transfer a plurality of different fluid flows through separate transfer plenums 932. In some embodiments, the transfer sleeve device 924 can be configured to transfer a first fluid flow to a pitch increase portion 934 of the PCM 926, a second fluid flow to a pitch decrease portion 936 of the PCM 926, and a third fluid flow to a drain portion 938 of the PCM 926. In some embodiments, when the PCM 226 is commended to a reverse position, the drain portion 938 can be pressurized and act to further rotate the actuator into the reverse position. The drain portion 938 does not always act to drain fluid from the PCM 926.

Although FIG. 11 illustrates the fluid flows being transferred between the stationary transfer sleeve member 902 and the rotatable transfer sleeve member 904 in a radial direction, in some embodiments, the transfer sleeve device 924 can be configured to transfer the fluid flows between the stationary transfer sleeve member 902 and the rotating transfer sleeve member 204 in an axial direction using flanges in a face-to-face abutment. Additionally, in some embodiments, the transfer sleeve member 902 may include the rotatable member of the transfer sleeve device 924 and the transfer sleeve member 904 may include the stationary member of the transfer sleeve device 924.

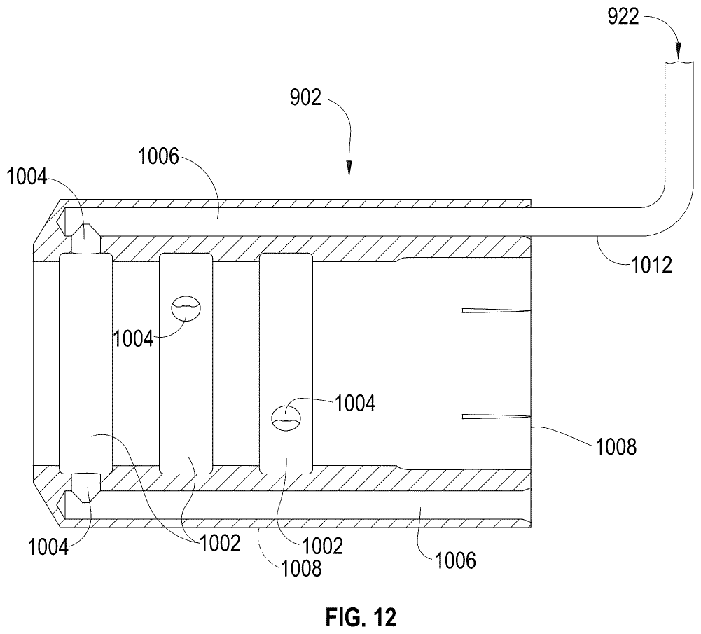

FIG. 12 is a side cutaway view of the stationary transfer sleeve member 902 of the transfer sleeve device 924. As shown, the stationary transfer sleeve member 902 includes a substantially cylindrical body configured to circumscribe rotatable the transfer sleeve member 904 when the transfer sleeve device 924 is fully assembled. As further shown, the stationary transfer sleeve member 902 includes three annular plenums 1002 that extend circumferentially about an inner surface of the stationary transfer sleeve member 902. Although described as three plenums, the stationary transfer sleeve member 902 can include any number of plenums. Each plenum 1002 is configured to direct a fluid flow across the gap 925 (FIG. 11) between the stationary transfer sleeve member 902 and the rotatable transfer sleeve member 904 to transfer the fluid flows into the rotatable transfer sleeve member 904. Each plenum 1002 includes at least one (e.g., one or a plurality of) respective port 1004 extending from a feed tube 1006 formed on an outer surface 1008 of the stationary transfer sleeve member 902. In the exemplary embodiment, stationary transfer sleeve member 902 includes two ports 1004 per plenum 1002 spaced approximately 180° apart. In some embodiments, stationary transfer sleeve member 902 can include a different number of ports 1004, and the ports 1004 may be spaced other than 180° apart with respect to each other. Since each feed tube 1006 supplies one port 1004 in the illustrated embodiment, the stationary transfer sleeve member 902 includes six feed tubes 1006 spaced circumferentially about the outer surface 1008. An inlet opening 1010 is fluidly coupled with a conduit 1012 from the gearbox flow path 922 (FIG. 11).

During operation, a fluid (e.g., hydraulic oil) is supplied to the PCM 926 (FIG. 11) through the conduit 1012 from the gearbox flow path 922 (FIG. 11), which channels the fluid flow into a respective feed tube 1006 or pair of feed tubes 1006. The fluid flow is directed through the port 1004 fluidly coupled with the respective feed tube 1006 or pair of feed tubes 1006. The fluid flows exiting ports 1004 are received in the rotatable transfer sleeve member 904 and are channeled to the PCM 926 (FIG. 11).

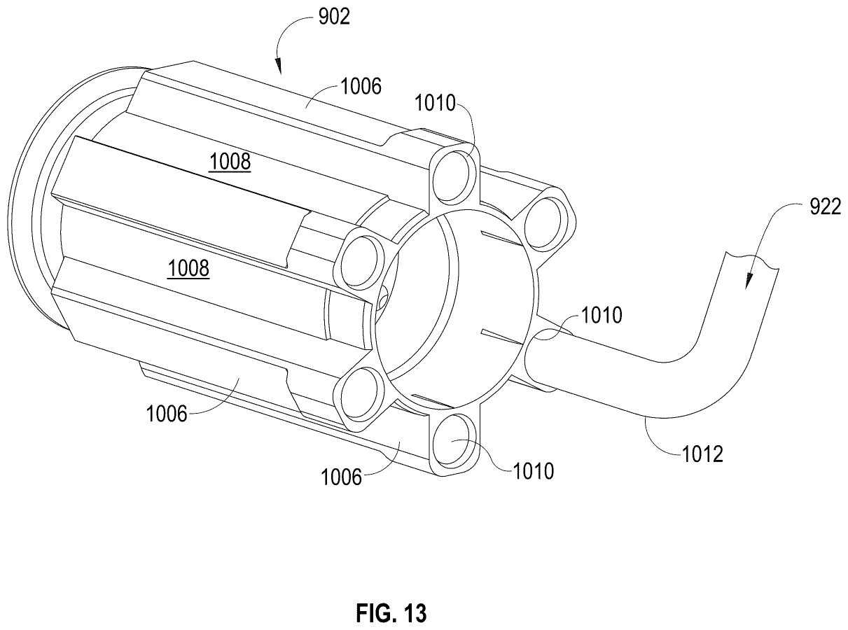

FIG. 13 is a perspective view of the stationary transfer sleeve member 902 of the transfer sleeve device 924. As shown, the stationary transfer sleeve member 902 includes a plurality of feed tubes 1006 formed in the radially outer surface 1008 the stationary transfer sleeve member 902. The feed tubes 1006 extend axially along the outer surface 1008 substantially parallel to a central axis (e.g., any one of central axes 112, 508, 608).

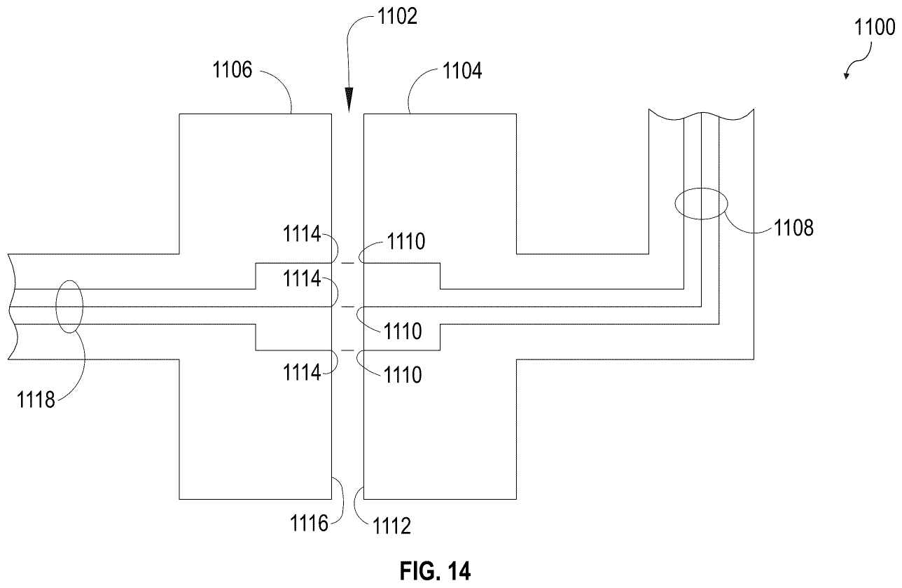

FIG. 14 is a side view of a fluid transfer device 1100 in accordance with exemplary aspect of the present disclosure. As shown, a fluid flow is transferred across a gap 1102 between a stationary flange transfer member 1104 and a rotatable flange transfer member 1106 in an axial direction. A plurality of fluid feed lines 1108 channel fluid from a fluid source (not shown) to one or more transfer ports 1110 formed in a face 1112 of the stationary flange transfer member 1104. One or more complementary receiver ports 1114 are formed in a face 1116 of the rotatable flange transfer member 1106. The receiver ports 1114 are fluidly coupled with their respective PCM actuator supply conduits 1118, which are configured to channel the flows of fluid to PCM 926 (FIG. 11).

The above-described fluid transfer systems provide an efficient method for supplying fluid from a stationary gas turbine engine component to a rotatable gas turbine engine component across a gap between the gas turbine engine components. Specifically, the above-described fluid transfer systems include fluid supply conduits that selectively supply a PCM actuator with hydraulic fluid for increasing a pitch of blades of a fan assembly, decreasing the pitch of the blades of the fan assembly, and draining fluid from the PCM actuator.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A gas turbine engine can include a turbomachine, a variable pitch primary fan, a secondary fan, and a fluid transfer system. The turbomachine can include a compressor section, a combustion section, and a turbine section arranged in a serial flow order. The turbomachine can define an engine inlet to an inlet duct, a fan duct inlet to a fan duct, and a core inlet to a core duct. The variable pitch primary fan can be driven by the turbomachine and include a plurality of fan blades and a hydraulic actuator configured to vary a pitch of one or more of the plurality of fan blades. The secondary fan can be located downstream of the primary fan within the inlet duct. The fluid transfer system can include a fluid source and a transfer sleeve device including a stationary member fluidly coupled to the fluid source and a rotatable member fluidly coupled to the hydraulic actuator. The fluid transfer system can be configured to transfer fluid between the fluid source and the stationary member, between the stationary member and the rotatable member, and between the rotatable member and the hydraulic actuator of the variable pitch fan. The gas turbine engine can define a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct.

The gas turbine engine of any clause herein, wherein the thrust to power airflow ratio and the core bypass ratio are defined when the gas turbine engine is operated at a rated speed during standard day operating conditions.

The gas turbine engine of any clause herein, wherein the thrust to power airflow ratio can be between 4 and 75.

The gas turbine engine of any clause herein, wherein the core bypass ratio can be between 0.3 and 5.

The gas turbine engine of any clause herein, wherein the gas turbine engine can be a geared gas turbine engine comprising a gearbox coupled to the variable pitch primary fan and the turbomachine.

The gas turbine engine of any clause herein, wherein the transfer sleeve device can be formed integrally with the gearbox.

The gas turbine engine of any clause herein, wherein said transfer sleeve device can be formed on a forward end of the gearbox.

The gas turbine engine of any clause herein, wherein said transfer sleeve device can be formed on an aft end of the gearbox.

The gas turbine engine of any clause herein, wherein the gearbox can include a gearbox flow path fluidly coupling the fluid source and the transfer sleeve device.

A method of operating a gas turbine engine can include operating the gas turbine engine at a rated speed, wherein operating the gas turbine engine at the rated speed can include operating the gas turbine engine to define a thrust to power airflow ratio between 3.5 and 100 and a core bypass ratio between 0.1 and 5. The thrust to power airflow ratio is a ratio of an airflow through a bypass passage over a turbomachine of the gas turbine engine plus an airflow through a fan duct to an airflow through a core duct, and the core bypass ratio is a ratio of the airflow through the fan duct to the airflow through the core duct. The method can further include receiving a fluid flow through one or more fluid supply conduits of the gas turbine engine, channeling the fluid flow through a gearbox flow path to a plenum formed on a stationary member of the gas turbine engine, transferring the fluid flow between the stationary member and a rotatable member of the gas turbine engine, and channeling the fluid flow through one or more flow ports to a hydraulic actuator of the gas turbine engine.

The method of any clause herein, wherein the thrust to power airflow ratio can be between 15 and 40.

The method of any clause herein, wherein the thrust to power airflow ratio can be between 20 and 35.

The method of any clause herein, wherein the core bypass ratio can be between 0.5 and 3.

The method of any clause herein, wherein the fluid flow can be one of a plurality of fluid flows, the plenum can be one of a plurality of axially-spaced plenums, and each one of the plurality of fluid flows can be channeled to a corresponding one of the plurality of plenums.

The method of any clause herein, wherein each one of the plurality of axially-spaced plenums can include two flow ports.

The method of any clause herein, wherein a first one of the plurality of fluid flows can be channeled to a pitch increase portion of the hydraulic actuator, a second one of the plurality of fluid flows can be channeled to a pitch decrease portion of the hydraulic actuator, and a third one of the plurality of fluid flows can be transferred to a drain portion of the hydraulic actuator.

A gas turbine engine can include a turbomachine comprising a compressor section, a combustion section, and a turbine section. The turbomachine can define an engine inlet to an inlet duct, a fan duct inlet to a fan duct, and a core inlet to a core duct. The gas turbine engine can further include a primary fan driven by a gearbox assembly coupled to the turbomachine via a shaft, wherein the primary fan can include a plurality of fan blades and a plurality of hydraulic actuators each coupled to a respective one of the plurality of fan blades. The gas turbine engine can further include a secondary fan located downstream of the primary fan within the inlet duct and a transfer sleeve device coupled to the gearbox assembly. The transfer sleeve device can be configured to receive a plurality of fluid flows and channel the plurality of fluid flows through respective ones of a plurality of flow ports to respective ones of the hydraulic actuators. The gas turbine engine can define a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct.

The gas turbine engine of any clause herein, wherein the transfer sleeve device can at least partially surround the shaft connecting the primary fan and the gearbox assembly.

The gas turbine engine of any clause herein, wherein the plurality of flow ports can be radially outwards-facing flow ports.

The gas turbine engine of any clause herein, wherein the primary fan, the compressor section, the combustion section, and the turbine section can be arranged in a serial flow order.

We claim:

1. A gas turbine engine comprising:
a turbomachine comprising a compressor section, a combustion section, and a turbine section arranged in a serial flow order, the turbomachine defining an engine inlet to an inlet duct, a fan duct inlet to a fan duct, and a core inlet to a core duct;
a variable pitch primary fan driven by the turbomachine comprising a plurality of fan blades and a hydraulic actuator configured to vary a pitch of one or more of the plurality of fan blades;
a secondary fan located downstream of the primary fan within the inlet duct, and
a fluid transfer system comprising:
a fluid source; and
a transfer sleeve device comprising a stationary member fluidly coupled to the fluid source and a rotatable member fluidly coupled to the hydraulic actuator,
wherein the fluid transfer system is configured to transfer fluid between the fluid source and the stationary member, between the stationary member and the rotatable member, and between the rotatable member and the hydraulic actuator of the variable pitch fan,
wherein the gas turbine engine defines a thrust to power airflow ratio between 3.5 and 100 and a core bypass ratio between 0.1 and 10,
wherein the thrust to power airflow ratio is a ratio of an airflow through a bypass passage over the turbomachine plus an airflow through the fan duct to an airflow through the core duct, and
wherein the core bypass ratio is a ratio of the airflow through the fan duct to the airflow through the core duct.

2. The gas turbine engine of claim 1, wherein the thrust to power airflow ratio and the core bypass ratio are defined when the gas turbine engine is operated at a rated speed during standard day operating conditions.

3. The gas turbine engine of claim 1, wherein the thrust to power airflow ratio is between 4 and 75.

4. The gas turbine engine of claim 1, wherein the core bypass ratio is between 0.3 and 5.

5. The gas turbine engine of claim 1, wherein the gas turbine engine is a geared gas turbine engine comprising a gearbox coupled to the variable pitch primary fan and the turbomachine.

6. The gas turbine engine of claim 5, wherein the transfer sleeve device is formed integrally with the gearbox.

7. The gas turbine engine of claim 5, wherein said transfer sleeve device is formed on a forward end of the gearbox.

8. The gas turbine engine of claim 5, wherein said transfer sleeve device is formed on an aft end of the gearbox.

9. The gas turbine engine of claim 5, wherein the gearbox comprises a gearbox flow path fluidly coupling the fluid source and the transfer sleeve device.

10. A method of operating a gas turbine engine, comprising:
operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5,
wherein the thrust to power airflow ratio is a ratio of an airflow through a bypass passage over a turbomachine of the gas turbine engine plus an airflow through a fan duct to an airflow through a core duct, and
wherein the core bypass ratio is a ratio of the airflow through the fan duct to the airflow through the core duct;
receiving a fluid flow through one or more fluid supply conduits of the gas turbine engine;
channeling the fluid flow through a gearbox flow path to a plenum formed on a stationary member of the gas turbine engine;
transferring the fluid flow between the stationary member and a rotatable member of the gas turbine engine; and
channeling the fluid flow through one or more flow ports to a hydraulic actuator of the gas turbine engine.

11. The method of claim 10, wherein the thrust to power airflow ratio is between 15 and 40.

12. The method of claim 11, wherein the thrust to power airflow ratio is between 20 and 35.

13. The method of claim 10, wherein the core bypass ratio is between 0.5 and 3.

14. The method of claim 10, wherein the fluid flow is one of a plurality of fluid flows, the plenum is one of a plurality of axially-spaced plenums, and each one of the plurality of fluid flows is channeled to a corresponding one of the plurality of plenums.

15. The method of claim 14, wherein each one of the plurality of axially-spaced plenums includes two flow ports.

16. The method of claim 14, wherein:
a first one of the plurality of fluid flows is channeled to a pitch increase portion of the hydraulic actuator,
a second one of the plurality of fluid flows is channeled to a pitch decrease portion of the hydraulic actuator, and
a third one of the plurality of fluid flows is transferred to a drain portion of the hydraulic actuator.

17. A gas turbine engine comprising:
a turbomachine comprising a compressor section, a combustion section, and a turbine section, the turbomachine defining an engine inlet to an inlet duct, a fan duct inlet to a fan duct, and a core inlet to a core duct;
a primary fan driven by a gearbox assembly coupled to the turbomachine via a shaft, wherein:
the primary fan comprises a plurality of fan blades and a plurality of hydraulic actuators each coupled to a respective one of the plurality of fan blades;
a secondary fan located downstream of the primary fan within the inlet duct; and
a transfer sleeve device coupled to the gearbox assembly, wherein the transfer sleeve device is configured to receive a plurality of fluid flows and channel the plurality of fluid flows through respective ones of a plurality of flow ports to respective ones of the hydraulic actuators,
wherein the gas turbine engine defining a thrust to power airflow ratio between 3.5 and 100 and a core bypass ratio between 0.1 and 10,
wherein the thrust to power airflow ratio is a ratio of an airflow through a bypass passage over the turbomachine plus an airflow through the fan duct to an airflow through the core duct, and
wherein the core bypass ratio is a ratio of the airflow through the fan duct to the airflow through the core duct.

18. The gas turbine engine of claim 17, wherein the transfer sleeve device at least partially surrounds the shaft connecting the primary fan and the gearbox assembly.

19. The gas turbine engine of claim 17, wherein the plurality of flow ports are radially outwards-facing flow ports.

20. The gas turbine engine of claim 17, wherein the primary fan, the compressor section, the combustion section, and the turbine section are arranged in a serial flow order.
